(19) United States
(12) Patent Application Publication
(10) Pub. No.: US 2022/0155485 A1
(43) Pub. Date: May 19, 2022

(54) DISTRIBUTED SYSTEM FOR ASSESSING EARTHQUAKES, HURRICANES OR OTHER NATURAL DISASTER EVENTS

(71) Applicant: New Paradigm Group, LLC, Fort Lauderdale, FL (US)

(72) Inventors: Evan M. Glassman, Fort Lauderdale, FL (US); Bradley I. Meier, Golden Beach, FL (US)

(21) Appl. No.: 17/520,117

(22) Filed: Nov. 5, 2021

Related U.S. Application Data
(63) Continuation of application No. 16/438,329, filed on Jun. 11, 2019.
(60) Provisional application No. 62/683,489, filed on Jun. 11, 2018.

(51) Int. Cl. G01W 1/06; G01V 1/00

(52) U.S. Cl. CPC G01W 1/06; G01W 2203/00; G01V 1/008

(57) ABSTRACT

The Abstract, as originally filed on November 5, 2021, is retained.

### CROSS-REFERENCE TO RELATED APPLICATIONS

This application is a continuation of U.S. patent application Ser. No. 16/438,329, filed Jun. 11, 2019, entitled METHOD AND SYSTEM FOR MULTI-TRIGGER PARAMETRIC DATA MANAGEMENT AND ASSOCIATED TRANSACTIONS (Atty. Dkt. No. NPUI60-34645), which claims the benefit of U.S. Provisional Application No. 62/683,489, filed on Jun. 11, 2018, entitled METHOD AND SYSTEM FOR MULTI-TRIGGER PARAMETRIC DATA MANAGEMENT AND ASSOCIATED TRANSACTIONS (Attorney Docket No. NPUI60-34144). All the foregoing, including patent application Ser. Nos. 16/438,329 and 62/683,489, are incorporated by reference herein in their entirety.

### TECHNICAL FIELD

The disclosed subject matter relates to a distributed system for assessing earthquakes, hurricanes and other natural disaster events to determine more accurate conditions.

### BACKGROUND

Devices such as anemometers for the measurement of wind speeds are known, and devices for recording wind speed data are also know. Recorded wind speed data from such devices may be valuable for resolving insurance claims resulting from storm damage. However, during severe weather, or in the aftermath of severe storms, the recording of wind speeds may be interrupted and/or the recorded wind speed data may be lost due to physical damage, lightning strikes, water intrusion, power loss, looting, vandalism or other causes adversely affecting the wind speed measurement and recording devices and/or the media upon which the wind speed data is stored. A need therefore exists, for processes to collect and manage alternative or supplemental parametric data for evaluating the effects of severe weather.

Even when recorded wind speed data remains intact, following a severe storm it may be difficult to obtain access to the locations where the recorded wind speed data is stored. This can result in delays in obtaining recorded wind speed data, which in turn can delay the resolution of insurance claims resulting from storm damage. A need therefore exists, for methods, systems and media for managing parametric weather data that provide multiple triggers for evaluating the effects for a weather event, for evaluating the multi-parametric data to determine if any of multiple trigger conditions have occurred and/or to determine if payment under a contract is indicated.

Although evaluating the effect of a weather event using recorded wind speed data is preferred when available, in some circumstances a geographic area may include some areas of interest not currently measurable by anemometers or other wind speed measuring devices. In other circumstances, measured wind speed data may be lost due to equipment or communication failures that occur during the weather event. In yet other circumstances, a geographic area may be subject to damage by natural phenomenon other than wind, for example, by abnormal tides, storm surges and or flooding that may accompany a weather event. In these cases, data from multiple types or sources of weather-related data can be evaluated to provide a more reliable indicator of the effects of a weather event. A need therefore exists, for methods and system for conducting multi-trigger parametric data management and associated transactions.

US Patent Application Publication US 2017/0104648 A1 discloses a system for collecting and managing wind speed data via an external communications network comprising one or more wind stations. US Patent Application Publication US 2018/0075537 A1 discloses is a system and a method for a parametric risk transfer system based on automated location-dependent probabilistic tropical storm risk and storm impact forecast. US Patent Application Publication US 2017/0104648 A1 and US Patent Application Publication US 2018/0075537 are each hereby incorporated by reference in their entirety.

### SUMMARY

In one aspect thereof, a method for collecting and managing multi-trigger parametric data is provided. The method comprises establishing, prior to an event, a first trigger condition based on comparison of first parametric data to a first set of input values and establishing, prior to the event, a second trigger condition based on comparison of second parametric data to a second set of input values. The method further comprising receiving, after the event, first values for the first parametric data resulting from the event and second values for the second parametric data resulting from the event. The method further comprises comparing, after receiving the first values, the received first values to the first set of input values to determine if the first trigger conditions are met, and comparing, after receiving the second values, the received second values to the second set of input values to determine if the second trigger conditions are met. The method further comprising determining, for each of the first and second trigger conditions that are met, a respective payout fraction of a maximum amount associated with each met condition. The method further comprises comparing the payout fraction corresponding to the met first trigger conditions with the payout fraction corresponding to the met second trigger conditions and determining the highest of such payout fractions to be the maximum met payout fraction, wherein the payout amount is the maximum amount multiplied by the maximum met payout fraction.

In one embodiment, the first trigger condition is a storm track inside a predefined closed geographical area when the storm winds speed is greater or equal to a predefined input wind speed.

In another embodiment of the first trigger condition, the predefined closed geographical area is a circle of predetermined radius drawn around a predetermined latitude/longitude point.

In yet another embodiment of the first trigger condition, the predefined closed geographical area is a square of predetermined side length centered on a predetermined latitude/longitude point.

In still another embodiment of the first trigger condition, the predefined closed geographical area is a rectangle defined by four predetermined latitude/longitude points.

In a further embodiment of the first trigger condition, the predefined closed geographical area is a polygon defined by a plurality of predetermined latitude/longitude points.

In a yet further embodiment of the first trigger condition, if the storm track crosses the predefined geographical area, and there is a single announced storm track data point within the predefined geographical area, then the determined storm wind speed for the predefined geographical area is the wind speed for the single announced storm track data point.

In a still further embodiment of the first trigger condition, if the storm track crosses the predefined geographical area, and there is a plurality of announced storm track data points within the predefined geographical area, then the determined storm wind speed for the predefined geographical area is the highest wind speed for any of the plurality of announced storm track data points within the predefined geographical area.

In another embodiment of the first trigger condition, if the storm track crosses the predefined geographical area, but there are no announced storm track data points within the predefined geographical area, then the determined storm wind speed for the predefined geographical area is the greater of the wind speed of the announced storm track data point immediately preceding entry into the predefined geographical area and the wind speed of the announced storm track data point immediately following exit from the predefined geographical area.

In yet another embodiment of the first trigger condition, if the storm track crosses the predefined geographical area, but there are no announced storm track data points within the predefined geographical area, then the determined storm wind speed for the predefined geographical area is the average of the wind speed of the announced storm track data point immediately preceding entry into the predefined geographical area and the wind speed of the announced storm track data point immediately following exit from the predefined geographical area.

In still another embodiment, the second trigger condition is a storm wind speed value at a predefined geographical location that is greater or equal to a predefined input wind speed.

In a further embodiment of the second trigger condition, the predefined geographical point is defined by a latitude/longitude pair.

In a yet further embodiment of the second trigger condition, the storm wind speed value is a measured wind speed determined by an anemometer located at the predefined geographical point.

In a still further embodiment of the second trigger condition, the storm wind speed value is a calculated wind speed determined by a wind field calculation for the predefined geographical location.

In another embodiment of the second trigger condition, if an anemometer at a predefined geographical location provides usable data, the storm wind speed value is a measured wind speed determined by the anemometer located at the predefined geographical location, and if the anemometer does not provide usable data, the storm wind speed value is a calculated wind speed determined by a wind field calculation for the predefined geographical location.

In another aspect thereof, a method for collecting and managing multi-trigger parametric data is provided. The method comprises establishing a first trigger condition based on comparison of first parametric data to a first set of input values and establishing a second trigger condition based on comparison of second parametric data to a second set of input values. The first parametric data is measured, wherein the first parametric data includes direct wind speed measured at a one or more geographic location, and producing respective wind speed signals indicative of the respective direct wind speeds at each respective one or more geographic location, wherein the respective wind speed signals are one of electric signals and electronic signals. The respective wind speed signals are converted into respective direct wind speed data at each respective one or more geographic location, wherein the respective direct wind speed data is digital data. The respective direct wind speed data are transmitted at each respective one or more geographic location as digital data onto an external communications network. The one or more data server receives the respective direct wind speed data as digital data for the respective one or more geographic location from the external communication network. The received respective first parametric data including the direct wind speed data for the respective one or more geographic location is stored on the one or more data server. At the one or more data servers, the second parametric data is received, wherein the second parametric data includes at least one of a storm track including position data, time data and wind speed data, a calculated wind field for a geographic region, or a tide level for a geographic location. The received second parametric data is stored on the one or more data server. At the one or more data server, it is determined if first parametric data meets the first trigger condition, and if so, there is determined a first payout fraction corresponding to the first trigger condition. At the one or more data server, it is determined if the second parametric data meets the second trigger condition and if so, there is determined a second payout fraction corresponding to the second trigger condition. When it is determined that the one or more of first or second trigger conditions are met, the highest payout fraction is determined of the first or second payout fraction and an indication of the highest payout fraction is transmitted to the payout server on the external communications network. When it is determined that none of the first or second trigger conditions are met, an indication that no payout is triggered is transmitted to the payout server on the external communications network.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a wind station system for managing wind speed data in accordance with some embodiments of the disclosed subject matter;

FIG. 1a is an enlarged view of the anemometer used in some embodiments of the wind station system of FIG. 1;

FIGS. 2a-2d show an overview of a tide gauge network in accordance with some embodiments, including examples of a tide station for managing water level data in accordance with additional embodiments, along with an exemplary tide gauge sensor, exemplary tide level data and exemplary geographic coverage map data, wherein:

FIG. 2a shows a tide station system;

FIG. 2b shows an close-up view of a tide sensor (or water level sensor);

FIG. 2c shows an example of a tide level system geographic coverage map including tide stations systems and/or tide sensors distributed at various geographic locations within an exemplary geographic area; and

FIG. 2d shows exemplary tide data collected from tide stations systems including predicted tide, observed water levels and water level variance or storm surge levels;

FIG. 3 shows an example of hardware for managing multi-trigger parametric data that can be used in accordance with some embodiments of the disclosed subject matter;

FIG. 4 shows an example of hardware implemented as a computing device in accordance with some embodiments of the disclosed subject matter;

FIGS. 5a, 5b and 5c show an exemplary process for managing multi-trigger parametric data and generating associated transaction data in accordance with some embodiments of the disclosed subject matter;

FIG. 6 an exemplary storm track map for a tropical storm including underlying geographic features, storm path location data and time data, and wind speed and direction data;

FIG. 7 shows an exemplary set of parametric wind triggers for a hurricane for use in a parametric wind triggered product for hurricanes in accordance with another embodiment;

FIG. 8 shows a calculated (i.e., modeled) wind footprint chart for an exemplary tropical storm (i.e., Hurricane Irma, 2017) at a first specified time in accordance with one type of parametric data used in embodiments disclosed herein, including underlying geographic feature data, storm center position data, graduated wind speed contour data, wind direction data, hurricane force wind contour line data and tropical storm force wind contour line data;

FIG. 9 shows a coverage territory map including calculated (i.e., modeled) wind footprint chart for the exemplary tropical storm of FIG. 8 at a second specified time;

FIG. 10 shows an exemplary coverage territory map including underlying geographic feature data, C-I-C calculation location data (i.e. “proxy station” in FIG.), C-I-C covered radius data, and storm center time/position data;

FIG. 11 shows an exemplary triggering mechanisms map including underlying geographic feature data, wherein the predefined geographical location is a circle of predefined radius around a predefined geographical point, i.e., Cat-in-a-Circle (“C-I-C”), showing calculation location data, C-I-C covered radius data, wind speed calculation location (anemometer) data, tide gauge calculation location data and storm track parametric data including multiple announced storm track data points, with respective time, position and wind speed data;

FIG. 12 shows an exposure map including underlying geographic feature data illustrating another exemplary triggering mechanism, wherein the predefined geographical location is a polygon defined by a plurality of latitude/longitude points, i.e., Cat-in-a-Box (“C-I-B”), showing a predefined geographical area (i.e., C-I-B location data) and storm track parametric data including multiple announced storm track data points, with respective time, position and wind speed data;

FIG. 13 shows a first exemplary premium indication based on multi-trigger (e.g., binary) parametric data management and transactions in accordance with embodiments of the disclosed subject matter including C-I-C calculation location inputs, C-I-C covered radius inputs, C-I-C category (CAT) magnitude threshold level inputs (1 . . . N₁), wind calculation location inputs (1 . . . N₂), wind threshold inputs (1 . . . N₃) and payout level inputs; and

FIG. 14 shows a second exemplary premium indication based on multi-trigger (e.g., binary) parametric data management and transactions in accordance with embodiments of the disclosed subject matter including C-I-C calculation location inputs, C-I-C covered radius inputs, C-I-C category (CAT) magnitude threshold level inputs (1 . . . N₁), wind calculation location inputs (1 . . . N₂), wind threshold inputs (1 . . . N₃) and payout level inputs

### DETAILED DESCRIPTION

In accordance with various embodiments of the disclosed subject matter, mechanisms (which can include methods, systems, and media) for managing wind speed data are described herein.

In one aspect, a method for collecting and managing multi-trigger parametric data comprises establishing, prior to an event, a first trigger condition based on comparison of first parametric data to a first set of input values and establishing, prior to the event, a second trigger condition based on comparison of second parametric data to a second set of input values. The event associated with the method is typically a weather-related event including, but not limited to, a hurricane, a tropical storm, a typhoon, a monsoon, a tidal wave, a surge tide, a flood, a tornado or a hail storm. However, the multi-trigger parametric data method is applicable to other types of future events including, but not limited to an earthquake, a volcano, a landslides or a forest fire.

The exact nature of the first and second trigger conditions is dependent upon the characteristics of the subject event, and in particular, to the anticipated damage-inflicting characteristics of the event. For example, if the subject event is a wind event such as a hurricane or tropical storm, the anticipated damage-inflicting characteristics are primarily related to storm path and maximum sustained wind speed, but may also be related to secondary damage mechanisms such as tidal surges, rainfall and/or flooding. In another example, if the subject event is a seismic event such as an earthquake, the anticipated damage-inflicting characteristics are primarily related to seismic magnitude and event duration, but may also be related to secondary damage mechanisms such as landslides and/or fires. The first and second trigger conditions are chosen to respond, respectively, to first and second parametric data.

The first and second trigger conditions, and thus the associated first and second parametric data may be completely or partially independent from one another. In one example of a hurricane event, the first trigger conditions and the first parametric data can relate to wind speed and duration values at a first geographical location and the and second trigger conditions and the second parametric data can relate to storm surge levels at a second geographical location. In another example of a hurricane event, the first trigger conditions/parametric data can relate to wind speed and duration values at a first geographical location and the and second trigger conditions/parametric data can relate to storm surge levels at the same first geographical location. In still another example of a hurricane event, the first trigger conditions/parametric data can relate to wind speed and duration values measured by an anemometer located at a first geographical location and the and second trigger conditions/parametric data can relate to announced (i.e., reported or officially acknowledged) storm track positions and wind speeds issued by a third party. In any event, at least some elements of the first trigger conditions/parametric data must be different from the second trigger conditions/parametric data. In some embodiments, the first and/or second parametric data can have a primary data set and a secondary data set, wherein values of the respective primary data set are normally used by the method for the respective parametric data values, but when values of the primary set are not available, the values of the respective secondary data set are used by the method.

In one embodiment, the first trigger condition is a storm track inside a predefined closed geographical area when the storm winds speed is greater or equal to a predefined input wind speed. The storm track can be, but is not limited to, a continuous track defined by a series of consecutive announced storm data points such as those produced/released by the National Hurricane Center (NHC) of NOAA. Each storm data point can include, e.g., a time, a geographical location (e.g., latitude/longitude pair) and a wind speed at that time/location. The wind speed can be provided in either physical units (e.g., miles per hour) or in categorical units, also known as “Category” or “Cat” units (e.g., Cat 1-5 of the Saffir-Simpson Hurricane scale, also known as the “Cat scale”). For example, the predefined geographical location can be a circle of predetermined radius drawn around a predetermined latitude/longitude point (sometimes known as “Cat-in-a-circle” if using Cat scale for wind speed). In another example, the predefined closed geographical area can be a square of predetermined side length centered on a predetermined latitude/longitude point (sometimes known as “Cat-in-a-box” if using the Cat scale). In still another example, the predefined closed geographical area can be a rectangle defined by four predetermined latitude/longitude points (also known as “Cat-in-a-box” if using the Cat scale). In a further example, the predefined closed geographical area can be any polygon defined by a plurality of predetermined latitude/longitude points.

Since the storm track can comprises a sequence of discrete announced storm data points, in different events where the storm track traverses the predefined closed geographical area, there may or may not be any announced storm data points within the boundaries of the closed geographical area. The trigger conditions can therefore be adapted to reflect the desired calculation mode for such conditions. For example, if the storm track crosses the predefined geographical area, and there is a single announced storm track data point within the predefined geographical area, then the determined storm wind speed for the predefined geographical area can be the wind speed for the single announced storm track data point, but if the storm track crosses the predefined geographical area, and there are a plurality of announced storm track data points within the predefined geographical area, then the determined storm wind speed for the predefined geographical area can be the highest wind speed for any of the plurality of announced storm track data points within the predefined geographical area. Further, in some examples, if the storm track crosses the predefined geographical area, but there are no announced storm track data points within the predefined geographical area, then the determined storm wind speed for the predefined geographical area can be the greater of the wind speed of the announced storm track data point immediately preceding entry into the predefined geographical area and the wind speed of the announced storm track data point immediately following exit from the predefined geographical area. Alternatively, if the storm track crosses the predefined geographical area, but there are no announced storm track data points within the predefined geographical area, then the determined storm wind speed for the predefined geographical area can be the average of the wind speed of the announced storm track data point immediately preceding entry into the predefined geographical area and the wind speed of the announced storm track data point immediately following exit from the predefined geographical area.

The previous examples of first trigger conditions are not limiting, for example, the first trigger condition could be any conditions based on comparison of first input values provided prior to the event and first parametric data values based on the event. For example, for tropical storm events, the first trigger condition can be based on first parametric data including surge tide levels, rainfall and/or flooding instead of wind conditions. In other types of events, the first trigger condition can be appropriately selected to correspond to an appropriate parametric data set.

In another embodiment, the second trigger condition is a storm wind speed value at a predefined geographical location that is greater or equal to a predefined input wind speed. The predefined geographical location for the second trigger condition can be a point defined by a latitude/longitude pair. The predefined geographical location is sometimes referred to as a “calculation point.” In one example of the second trigger condition, the storm wind speed value is a measured wind speed determined by an anemometer located at the predefined geographical location. In another example of the second trigger condition, the storm wind speed value is a calculated wind speed determined by a wind field calculation for the predefined geographical location. The wind field calculation can be a parametric data set provided by the user or by a third party including, but not limited to, RMS® data sets that can be obtained from servers at Risk Management Solutions, Inc. In yet another example, if an anemometer at a predefined geographical location provides usable data, the storm wind speed value is a measured wind speed determined by the anemometer located at the predefined geographical location, and if the anemometer does not provide usable data, the storm wind speed value is a calculated wind speed determined by a wind field calculation data set for the predefined geographical location.

The previous examples of second trigger conditions are not limiting, for example, the second trigger condition could be any conditions based on comparison of second input values provided prior to the event and second parametric data values based on the event, provided, however, that the second parametric data is at least partially independent of the first parametric data.

After the occurrence of a subject event, the values of the first parametric data and the values of the second parametric data must be obtained determine if the first trigger conditions and/or the second trigger conditions are met. Each of the first and second trigger conditions may define, respectively, a plurality of levels of meeting the respective trigger condition. For example, if the first trigger condition is based on a wind speed category (“CAT”) level, a first level of the first trigger condition can be met by a Cat 1 storm, a second level of the first trigger condition can be met by a Cat 2 storm, a third level of the first trigger level can be met by a Cat 3 storm, etc. The method further comprising determining, for each of the first and second trigger conditions that are met, a respective payout fraction of a maximum amount associated with each met condition. For the previous example, a first payout fraction for meeting the first level of the first trigger condition can be 25% of maximum amount, a second payout fraction for meeting the second level of the first trigger condition can 50% of the maximum amount, a third payout fraction for meeting the third level of the first trigger level can be 100% of the maximum amount. A substantially similar set of steps is run, respectively, for the second trigger conditions, including multiple levels and payout fractions, if applicable. It will be understood that the methods disclosed herein are not limited to only first and second trigger conditions, but may further comprise additional trigger conditions based on additional input values and additional parametric data, levels and payout fractions.

After determining the respective payout fractions for each of the trigger conditions sets, the highest of such payout fractions is selected to be the maximum met payout fraction, and the payout amount is determined as the maximum amount multiplied by the maximum met payout fraction.

For purposes of explanation and illustration, some of the exemplary systems and methods described herein include only first and second trigger conditions based on two corresponding sets of parametric data; however, these systems and methods described herein are not limited to only two trigger conditions nor to only two corresponding sets of parametric data. Rather, the systems and methods described herein allow the consideration of essentially unlimited numbers of trigger conditions and corresponding sets of parametric data. For one example, a first trigger condition can be a “Cat-in-a-Circle” or “Cat-in-a-Box” type condition covering a large predefined geographical area with the parametric data being reported storm track data, and ten additional trigger conditions can be set for sustained wind speed values at ten different anemometer locations (e.g., calculation locations) defined by specific latitude/longitude pairs, thus providing eleven independent trigger conditions driven by eleven sets of corresponding parametric data. After an event, each of the eleven trigger conditions can be evaluated, and the largest payout fraction corresponding to any of the met trigger conditions can be used to determine the payout.

For an even large example, a first trigger condition can be a “Cat-in-a-Circle” based on a first, circular-shaped geographic location defined by a center location and a radius, with the corresponding parametric data set being reported NHC storm track data, a second trigger condition can be a “Cat-in-a-Box” based on a second, irregular polygonal-shaped geographic location defined by a set of boundary points (e.g., specific latitude/longitude pairs at the vertices of the polygon) with the corresponding parametric data set also being reported NHC storm track data, the third through twelfth trigger conditions can be set for sustained wind speed values at ten different anemometer locations (defined by specific latitude/longitude pairs), and the thirteenth through twenty-second trigger conditions can be set for tide level values at ten different tide gauge locations (also defined by specific latitude/longitude pairs), thus providing twenty-two independent trigger conditions driven by corresponding parametric data. After an event, each of the trigger conditions can be evaluated against the associated parametric data, and the largest payout fraction corresponding to any of the met trigger conditions can be used to determine the payout. In some cases where the trigger conditions are defined by different input values, the same set of parametric data can be used to evaluate more than one of the trigger conditions, for example, when the parametric data set is NHC reported storm track data, two or more trigger conditions having different geographical boundaries can be independently evaluated using the same parametric data.

When large numbers of trigger conditions are set for an event, thus involving management of a very large number of input values sets and management and evaluation of very large quantities of parametric data corresponding to trigger condition, the systems and methods described herein can be executed in an automated fashion as provided herein to provide fast and accurate determination of payout amounts, which are essential when responding to large-scale events such as hurricanes and other weather events or damaging natural phenomena.

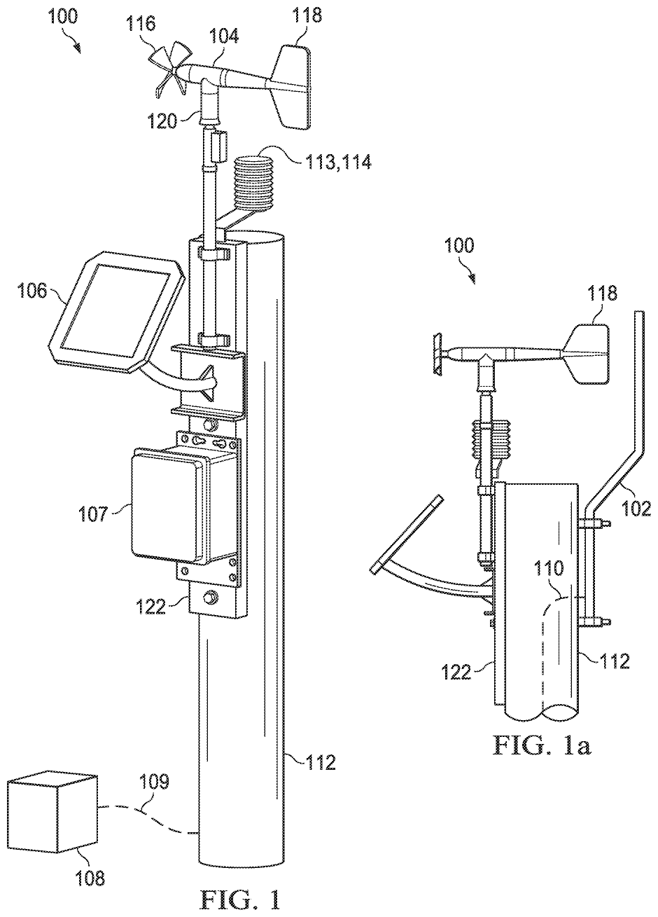

Referring now FIGS. 1 and la, there is illustrated an example of a wind station system 100 for collecting and managing wind speed data in accordance with some embodiments of the disclosed subject matter. In some embodiments, the wind station system 100 is disposed at a particular geographic location and manages wind speed data for winds occurring at the particular geographic location. As shown, in some embodiments, the wind system can include a lightning terminal 102 (i.e., lightning rod), an anemometer 104, a solar panel 106, a battery box 107, a computing device 108, a ground wire 110 and a pole 112. In some embodiments, the computing device 108 can be located on the pole 112, whereas in other embodiments, the computing device can be located remotely from the pole (e.g., in a secure location) and connected to the anemometer 104 via a data link 109. In some embodiments the data link 109 can be a wired connection (e.g., electrical wires, optical fibers, etc.) and in other embodiments the data link can be a wireless connection (e.g., Wi-Fi, cellular radio, radio etc.). The wind system can further include a temperature gauge/thermometer 113 and/or a humidity gauge 114. In some embodiments, all of these elements can be disposed at the particular geographic location, whereas in other embodiments, some of the elements may be disposed at different geographic locations. It should be understood that although only one of each of these elements is shown in FIG. 1, more than one of each of these elements can be used in some embodiments.

In some embodiments, any lightning terminal 102 suitable for conducting the electric charge of a lightning strike away from other components can be used. For example, the lightning terminal 102 can comprise an electrically conductible rod, an electrically conductible wire 110, and/or any other electrically conductible part or assembly of parts. In the illustrated embodiment, the lightning terminal 102 includes copper wire 110 routed internal to the support pole 112.

In some embodiments, the lightning terminal 102 can be connected to the ground wire 110 such that in the event of a lightning strike, the electric charge will be grounded to the earth. In some embodiments, any suitable ground wire 110 can be used. For example, the ground wire 110 can be a copper wire, a shielded wire, an insulated wire and/or any other type of wire suitable for grounding an electric charge.

In some embodiments, the ground wire 110 can be inserted at any suitable depth into the earth. For example, a ground wire 110 can be inserted into the earth to a depth of 20 feet below the ground level (i.e., surface) at the location.

Referring still to FIGS. 1 and 1a, in some embodiments, any anemometer 104 suitable for measuring wind speeds can be used. For example, referring now specifically to FIG. 1a, in the illustrated embodiment the anemometer 104 may include a propeller 116. In some such embodiments, the anemometer 104 can produce an electrical signal when the propeller 116 is rotated by wind. In a more particular example, the propeller 116 can produce an AC sine wave electrical signal. In another more particular example, the propeller 116 can be configured to produce an electrical signal directly proportional to wind speed. The anemometer 104 may further include a tail assembly 118 and a swivel bearing 120 rotatably connected to the pole 112, whereby the action of the wind on the tail assembly causes the anemometer to rotate horizontally on the swivel bearing to keep the propeller facing into the wind. In some embodiments, the anemometer 104 can be implemented without a propeller 116 using other moving apparatus, for example, moving cups, vanes, rotors and/or with non-moving apparatus, for example, a pitot tube assembly, to measure the wind speed. In other embodiments, the anemometer 104 can produce electrical signals (e.g., analog voltage, current, frequency or phase signals) or electronic signals (e.g., digital electric signals) proportional to the measured wind speed and/or indicative of the measured wind speed at the anemometer's geographic location.

In some embodiments of the wind station system 100, each component of the measuring system (e.g., solar panel 106, anemometer 104 and battery box 107) is attached to the aluminum channel with four ⅜ inch stainless steel bolts. In some embodiments, the solar panel 106 and mount can be of the type sold by Sol, Inc. of Palm City, Fla., USA. In some embodiments of the wind station system 100, a mounting bracket 122 can be used to attach components to the pole 112. In one embodiment, the mounting bracket 122 is a fabricated aluminum channel bracket ¼ inch thick having 7.5 inch flange×1.75 inch legs×43 inches long.

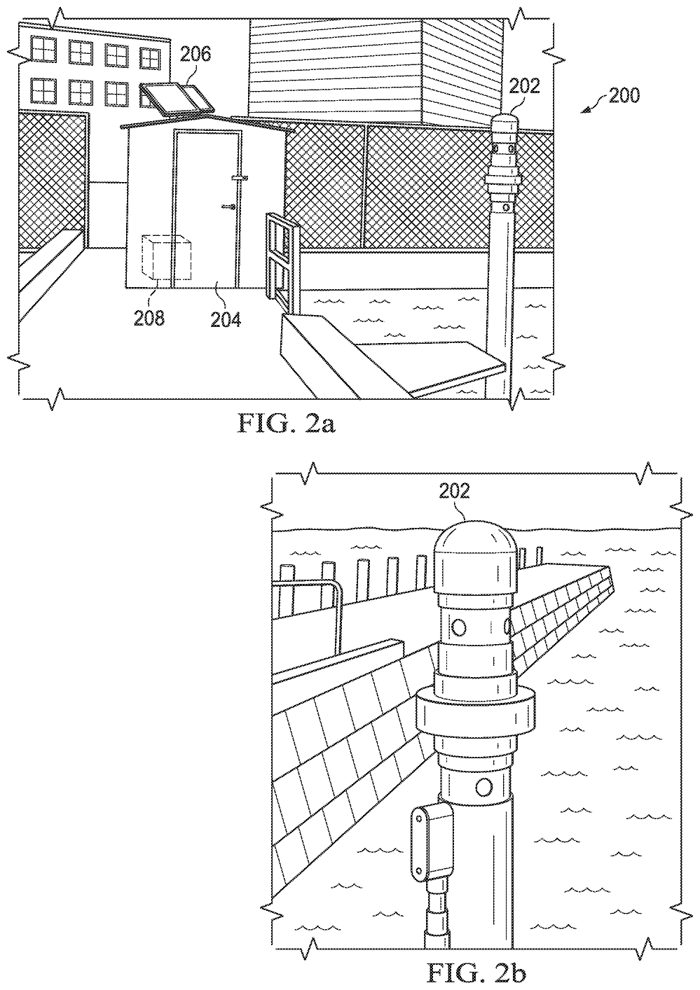

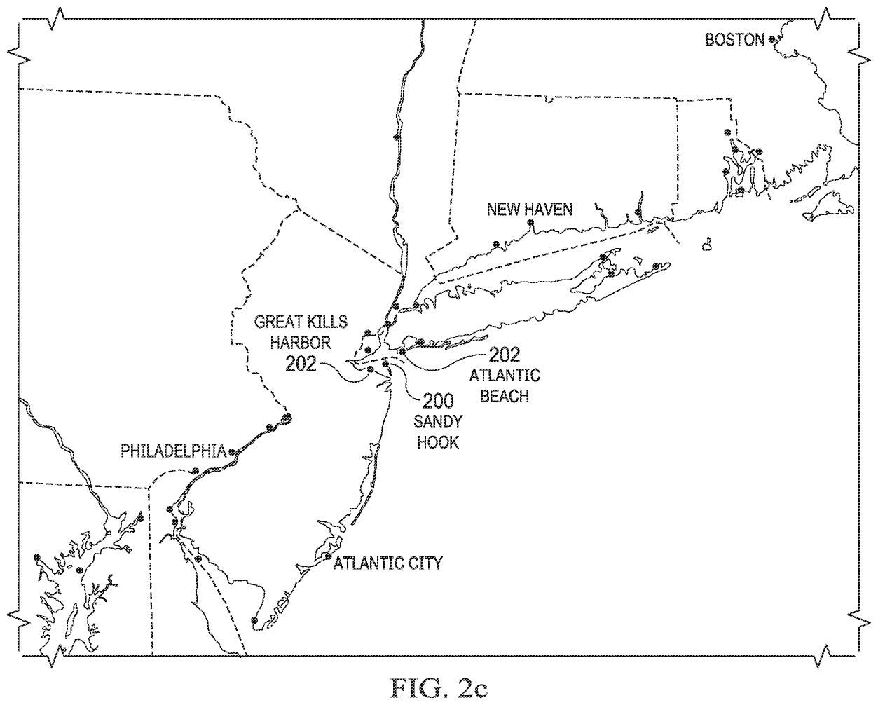

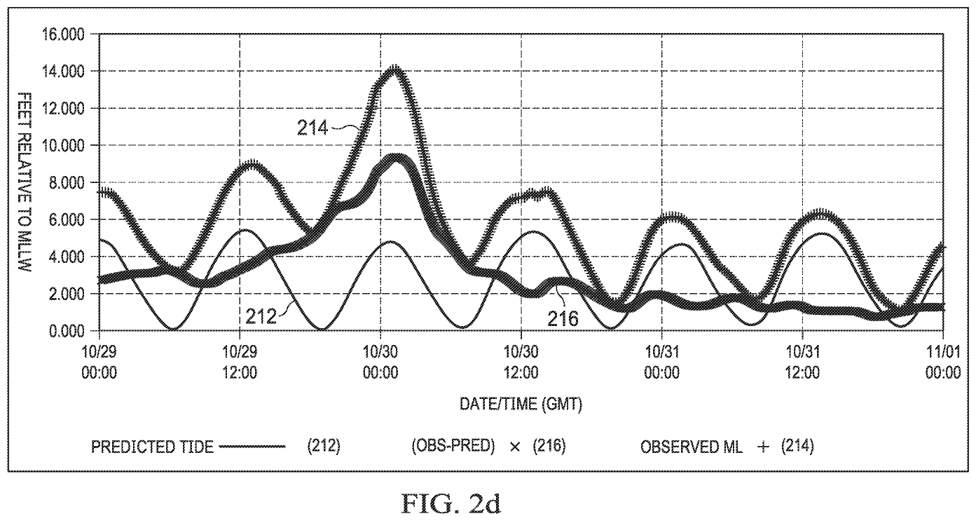

Referring now to FIGS. 2a-2d, there is illustrated an example of a tide station system 200 and a tide sensor 202 for collecting and managing water level data (also referred to as tide level data), and also exemplary water level data 210 in accordance with some embodiments of the disclosed subject matter. In some embodiments, the tide station system 200 is disposed at a particular geographic location (see map in FIG. 2c) and manages tide data and/or water level data only for water levels occurring at the particular geographic location. In other some embodiments, one tide station system 200 disposed at a particular geographic location can manages tide data and/or water level data for water levels occurring a plurality of geographic locations remote from the particular geographic location, e.g., one or more remote locations having tide sensors 202. As shown in FIG. 2a, in some embodiments, the tide station system 200 can include a water level sensor unit 202 (FIG. 2b), an instrument shed 204, a solar panel 206 and a computing device 208 (shown in phantom; typically located with the shed). In some embodiments, all of these elements can be disposed at the particular geographic location, whereas in other embodiments, some of the elements may be disposed at different geographic locations. It should be understood that although only one of each of these elements is shown in FIG. 2, more than one of each of these elements can be used in some embodiments.

Referring to FIG. 2d, exemplary water level data/tide data 210 for a particular geographic area can be produced comprising plots of water level, e.g., measured in feet relative to MLLW (Mean Lower Low Water), for a predicted tide (line 212 in FIG. 2d), i.e., astronomical tide, and for an observed water level (line 214 in FIG. 2d) over a selected time period. In some embodiments, the predicted/astronomical tide values 212 can come from so-called tide tables or from tide models. In some embodiments, the observed water level values 214 can come from tide system stations 200 and/or water level sensors 202. The difference between the observed water level 214 and predicted tide 212 (i.e., value of line 214 minus value of line 212) can be considered the storm surge value (line 216 in FIG. 2d), since the storm surge is defined as an abnormal rise of water generated by a storm, over and above the predicted astronomical tides.

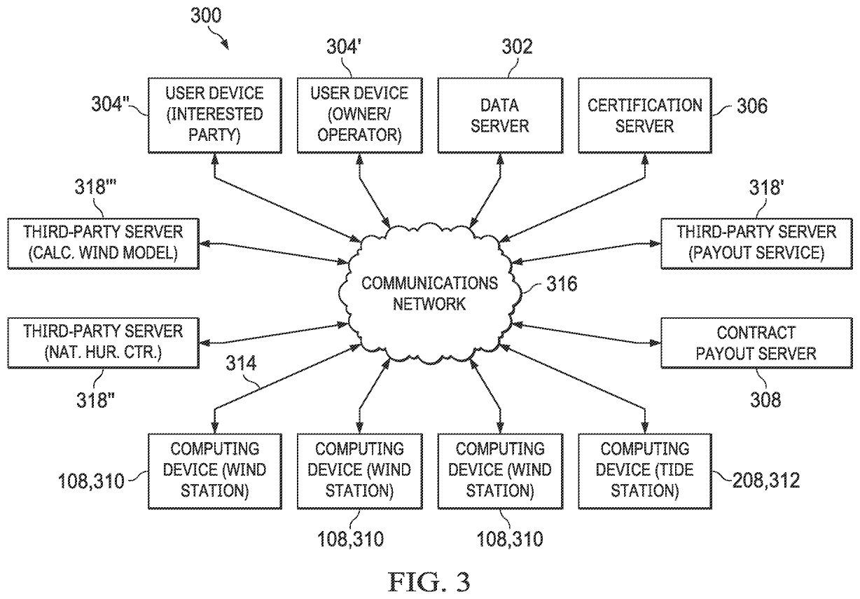

Referring now to FIG. 3, there is illustrated one example of system hardware for managing multi-trigger parametric data 300 that can be used in accordance with some embodiments of the disclosed subject matter. As illustrated, the system hardware 300 can include one or more: data servers 302, user devices 304, certification servers 306, contract payout servers 308, wind stations 310 with computing devices 108 and, optionally, tidal stations 312 with computing devices 208.

In some embodiments, the wind station 310 can be any suitable wind station configured with a wind measuring device and a computing device. For example, as shown in FIG. 1, the wind station can be the wind station system 100 with anemometer 104 disposed at a particular geographic location.

In some embodiments, the tide station 312 can be any suitable tide station configured with a water level measuring device and a computing device. For example, as shown in FIG. 2a, the tide station 312 can be the tide station system 200 with tide gauge (i.e., water level gauge) 202 disposed at a particular geographic location.

In some embodiments, the data server 302 can be any suitable server for storing data and/or delivering the data to a user device 304. In some embodiments, the data stored by the data server 302 and/or delivered to the user device 304 can be implemented as digital data in any digital data format. For example, the data server 302 can be a server that delivers data to a user device 304 and/or receives data from a wind station 310 via a communication network 316. In some embodiments, the data server 302 can include a server computing device (e.g., hardware 400) having a server communication interface operatively connected to the communication network 316 to receive respective wind speed data from one or more wind stations 310 and operatively connected to the server computing device to provide the received respective wind speed data to the server computing device and a server memory disposed at the respective data server location and operatively connected to the server computing device for storing the received respective wind speed data. In some embodiments, the data server 302 can include a server computing device 400 having a server communication interface operatively connected to the communication network 316 to receive respective tide/water level data (e.g., data 210) from one or more tide stations 312 and operatively connected to the server computing device to provide the received respective tide/water level data to the server computing device and a server memory disposed at the respective data server location and operatively connected to the server computing device for storing the received respective tide/water level data. Data stored and/or delivered by the data server 302 can be any suitable data, such as wind speed data, wind direction data, tide data, water level data, historical weather data, historical tide data, historical water level data, contract data, contract payout data and/or any other suitable data. Data can be recorded and uploaded to the data server 302 by any suitable entity (e.g., a wind station computing device or a tide station computing device). In some embodiments, the data server 302 can be disposed at a geographic location that is remote from (i.e., geographically distant from) the wind station 310, wind station system 100, tide station 312 or tide station system 200, whereas in other embodiments, the data server can be disposed at the same geographic location as the wind station, wind station system, tide station or tide station system. In some embodiments having more than one wind station system 100 and/or tide station system 200, each respective wind station system 100 or tide station system 200 can be disposed at a different respective wind or tide station location, and the data server 302 can be disposed at a data server location that is remote from at least one of the respective wind or tide station locations. In some embodiments having more than one wind station system 100 or tide station system 200 and more than one data server 302, each respective wind station system or tide station system can be disposed at a different respective wind station or tide station location, and each respective data server can be disposed at a different respective data server location, wherein the respective wind or tide station locations and data server locations are all geographically remote from one another. In some other embodiments, the data server 302 can be omitted.

The communication network 316 can be any suitable combination of one or more wired and/or wireless networks in some embodiments. For example, the communication network 316 can include anyone or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. The user device 304 can be connected by one or more communications links 314 to the communication network 316, which can be linked via one or more communications links to the data server 302, and/or wind stations 310, and/or tide station 312. The communications links 314 can be any communications links suitable for communicating data among the user device 304, data server 302, wind stations 310 and/or tide stations 312, such as network links, dial-up links, wireless links, hard-wired links, any other suitable communications links, or any suitable combination of such links. In some embodiments, the data communicated across the communication network 316 and/or communication links 314 can be implemented as digital data in any digital data format.

The user device 304 can include any one or more user devices suitable for requesting data, searching for data, viewing data, retransmitting data, manipulating data, receiving a user input and/or any other suitable functions. For example, in some embodiments, the user device 304 can be implemented as a mobile device, such as a mobile phone, a tablet computer, a laptop computer and/or any other suitable mobile device. As another example, in some embodiments, the user device 304 can be implemented as a non-mobile device such as a desktop computer and/or any other suitable non-mobile device. In some embodiments, the user device 304 can be disposed at a geographic location that is remote from (i.e., geographically distant from) the wind station system 100, the tide station system 200 and/or the data server 302, whereas in other embodiments, the user device can be disposed at the same geographic location as the wind station system, the tide station system and/or the data server. Some embodiments can have multiple user devices 304, wherein the owner/operator of the system controls or operates one user device 304′ and other interested parties (e.g., customers, vendors, contractors, etc.) control or operate another of the user devices 304″.

In some embodiments, the contract payout server 308 can be any suitable server for causing a contract to be paid out based on wind speed data and/or tide or water level data. For example, the contract payout server 308 can be a server that receives wind speed data and or tide data from a data server 302 via a communication network 316, and/or determines whether a contract should be paid out based on wind speed data and/or tide data and/or causes a third party server (e.g., third party payout service 318′) to payout a contract by communicating with the third party server over the communication network. The storage of the wind speed data, tide data and other information, programs, data and/or other suitable information on the contract payout server 308 can be implemented as digital data in any digital data format. In some embodiments, the payout server 308 can include a payout server computing device (e.g., hardware 400) having a payout server communication interface operatively connected to the communication network 316 to receive respective certification reports from one or more certification servers 306 and operatively connected to the payout server computing device to provide the received respective certification reports to the payout server computing device, and/or a payout server memory operatively connected to the payout server computing device for storing the received respective certification reports. In some embodiments, the payout server computing device of the contract payout server 308 can determine if a received respective certification report satisfied the terms of an associated contract, and if so, the payout server can trigger a payout at another location by communicating over the communication network 316 In some embodiments, the contract payout server 308 can be disposed at a geographic location that is remote from (i.e., geographically distant from) the wind station 310, wind station system 100, tide station 312, tide station system 200, the data server 302 and/or the user device 304, whereas in other embodiments, the contract payout server can be disposed at the same geographic location as the wind or tide station, wind or tide station system, the data server and/or the user device.

In some embodiments, third party servers 318 can be any suitable server for providing data including parametric data such as measured wind speed data and measured tide data. Third party servers 318 can also supply other forms of parametric data including, but not limited to, real time or historical calculated (i.e., modeled) wind field data, historical wind data, historical tide data, historical water level data, real time or historical storm tracks. In some embodiments, one third party server 318″ can be any server at the National Hurricane Center operated by NOAA. In some embodiments, one third party server 318′″ can be any server providing RMS® North Atlantic Hurricane Models from Risk Management Solutions, Inc. of Newark Calif.

In some embodiments, the certification server 306 can be any suitable server for certifying wind speed data, tide data or other parametric data. For example, the certification server 306 can be a server that receives wind speed data, tide data and/or water level data from a data server 302 via a communication network 316, and/or stores historical wind speed data, tide data and/or water level data and/or determines whether wind speed data, tide data and/or water level data is accurate. The storage of the wind speed data, tide data, and other information, programs, data and/or other suitable information on the certification server 306 can be implemented as digital data in any digital data format. In some embodiments, the certification server 306 can include a certification server computing device (e.g., hardware 400) having a certification server communication interface operatively connected to the communication network 316 to receive respective wind speed data, tide data and/or water level data from one or more data servers 302 and operatively connected to the certification server computing device to provide the received respective wind speed data, tide data and/or water level data to the certification server computing device, and/or a certification server memory operatively connected to the certification server computing device for storing the received respective wind speed data, tide data and/or water level data. In some embodiments, the certification server computing device of the certification server 306 can generate a data model, for example a historical storm model, a wind speed damage model, a historical tide model, a tide damage model, a historical storm surge (e.g., water level) model, and/or a storm surge damage model and the generated data model can be transmitted by the certification server communication interface to another location on the communication network 316. In some embodiments, the certification server computing device of the certification server 306 can generate a certification report based on the received wind speed data and the generated data model, and/or the received tide data and the generated data model, and/or on the received water level data and the generated water level model, and the certification report can be transmitted by the certification server communication interface to another location on the communication network 316. In some embodiments, the certification server 306 can be disposed at a geographic location that is remote from (i.e., geographically distant from) the wind or tide station systems 100, 200, the data server 302, the user device 304 and/or the contract payout server 308, whereas in other embodiments, the contract payout server can be disposed at the same geographic location as the wind station system, the data server, the user device and/or the contract payout server.

Although the data server 302 and the user device 304 are illustrated as separate devices in FIG. 3, the functions performed by the data server and the user device can be performed using any suitable number of devices in some embodiments. For example, in some embodiments, the functions performed by either the data server 302 or the user device 304 can be performed on a single device. As another example, in some embodiments, multiple devices can be used to implement the functions performed by the data server 302 and the user device 304.

Although the data server 302, certification server 306, and the contract payout server 308 are illustrated as separate devices in FIG. 3, the functions performed by the data server, certification server and the contract payout server can be performed using any suitable number of devices in some embodiments. For example, in some embodiments, the functions performed by either the data server 302, the certification server 306, or the contract payout server 308 can be performed on a single device. As another example, in some embodiments, multiple devices can be used to implement the functions performed by the data server 302, the certification server 306 and the contract payout server 308.

Although only three wind stations 310, one tide station 312, one certification server 306, one contract payout server 308, one data server 302, two user devices 304 and three third-party server 318 are shown in FIG. 3 to avoid over-complicating the figure, any suitable number and/or any suitable types of wind stations, tide stations, data servers, user devices and third-party servers can be used in some embodiments.

The data server 302, the user device 304, the wind station computing device 108 and the tide station computing device 208 can be implemented using any suitable hardware in some embodiments. For example, in some embodiments, the data server 302, the user device 304, the wind station computing device 108 and the tide station computing device 208 can be implemented using any suitable general purpose computer or special purpose computer. In another example, the wind station computing device 108 may be implemented using a special purpose computer. In yet another example, the tide station computing device 208 may be implemented using a special purpose computer. Any such general purpose computer or special purpose computer can include any suitable hardware. Such hardware can include a hardware processor, a memory and/or storage, an input device controller, an input device, display/audio drivers, display and audio output circuitry, a communication interface(s), an antenna and a bus as further described herein.

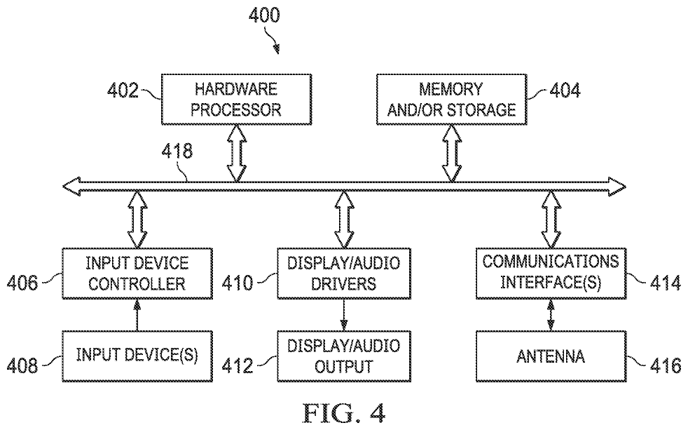

Referring now to FIG. 4, there is illustrated one example of computer hardware 400 implemented as the computing device 108, 208 for the wind station 310 or the tide station 312, respectively, in accordance with respective embodiments. In some other embodiments, any suitable computing device can be used. As illustrated in FIG. 4, the computer hardware 400 can include a hardware processor 402, a memory and/or storage 404, an input device controller 406, an input device 408, display/audio drivers 410, display and audio output circuitry 412, a communication interface(s) 414, an antenna 416 and a bus 418.

The hardware processor 402 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, the hardware processor 402 can be controlled by a program stored in the memory and/or storage 404. For example, the program can cause the hardware processor 402 to perform the mechanisms and/or processes described herein for managing wind speed data, and/or perform any other suitable actions.

The memory and/or storage 404 can be any suitable memory and/or storage for storing application information, programs, data, and/or any other suitable information in some embodiments. For example, the memory and/or storage 404 can include random access memory (“RAM”), read-only memory (“ROM”), flash memory, hard disk storage, optical media and/or any other suitable memory.

The input device controller 406 can be any suitable circuitry for controlling and receiving input from one or more input devices 408 in some embodiments. For example, the input device controller 406 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, from a wind speed sensor 104 (FIG. 1) or tide sensor 202 (FIG. 2) and/or from any other type of input device 408.

The display/audio drivers 410 can be any suitable circuitry for controlling and driving output to one or more display/audio output devices 412 in some embodiments. For example, the display/audio drivers 410 can be circuitry for driving a touchscreen, a flat-panel display, a cathode ray tube display, a projector, a speaker or speakers and/or any other suitable display and/or presentation devices 412.

The communication interface(s) 414 can be any suitable circuitry for interfacing with one or more communication networks, such as the communication network 316 shown in FIG. 3 and previously described. For example, the interface(s) 414 can include network interface card circuitry, wireless communication circuitry and/or any other suitable type of communication network circuitry. The communication interface(s) 414 can also include circuitry for interfacing with external devices including the storage device and/or the memory 404 for storing and/or retrieving wind speed data and/or tide data or water level data from the storage device and/or the memory. In some embodiments, the wind speed data and/or tide data or water level data can be stored in the storage device and/or the memory 404 as digital data and/or can be transmitted to, or received from, the communication network as digital data.

The antenna 416 can be any of one or more suitable antennas for wirelessly communicating with a communication network (e.g., the communication network 316 of FIG. 3 as previously described) in some embodiments. In some embodiments, the antenna 416 can be internal to the hardware 400 or omitted.

The bus 418 can be any suitable mechanism for communicating between two or more components in some embodiments. The communication between the components of the computer hardware 400 along the data bus 418 can be implemented as digital data.

Any other suitable components can be included in hardware 400 in accordance with some embodiments.

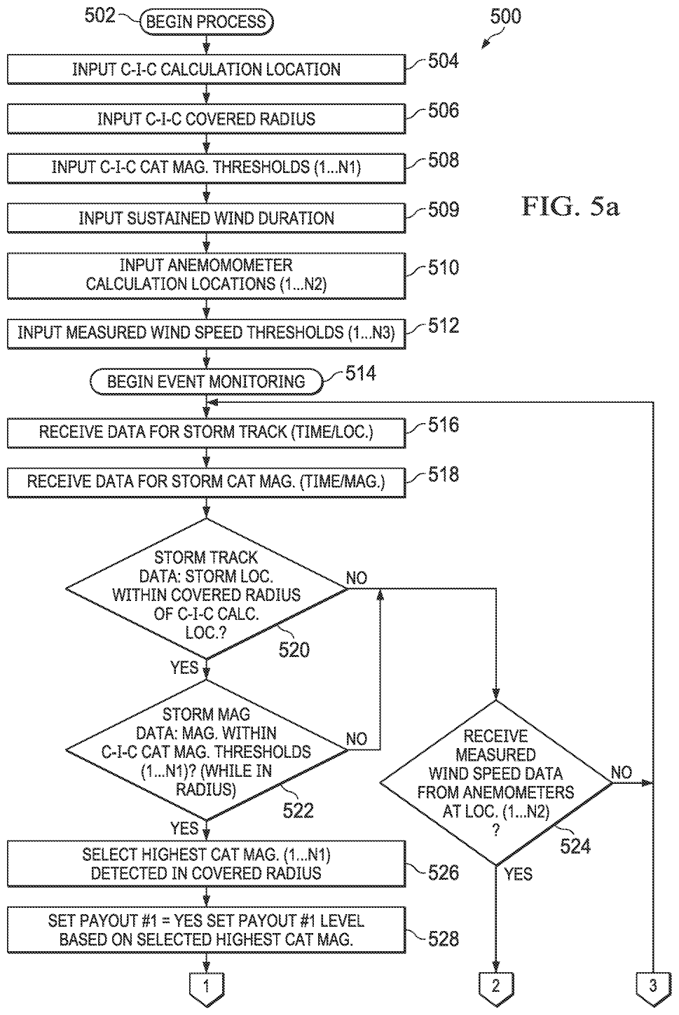

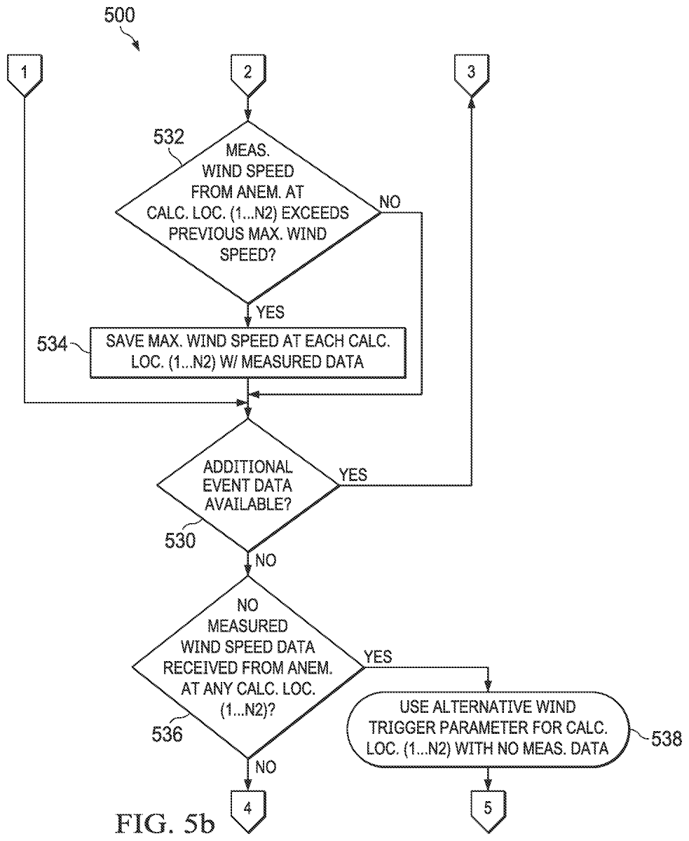

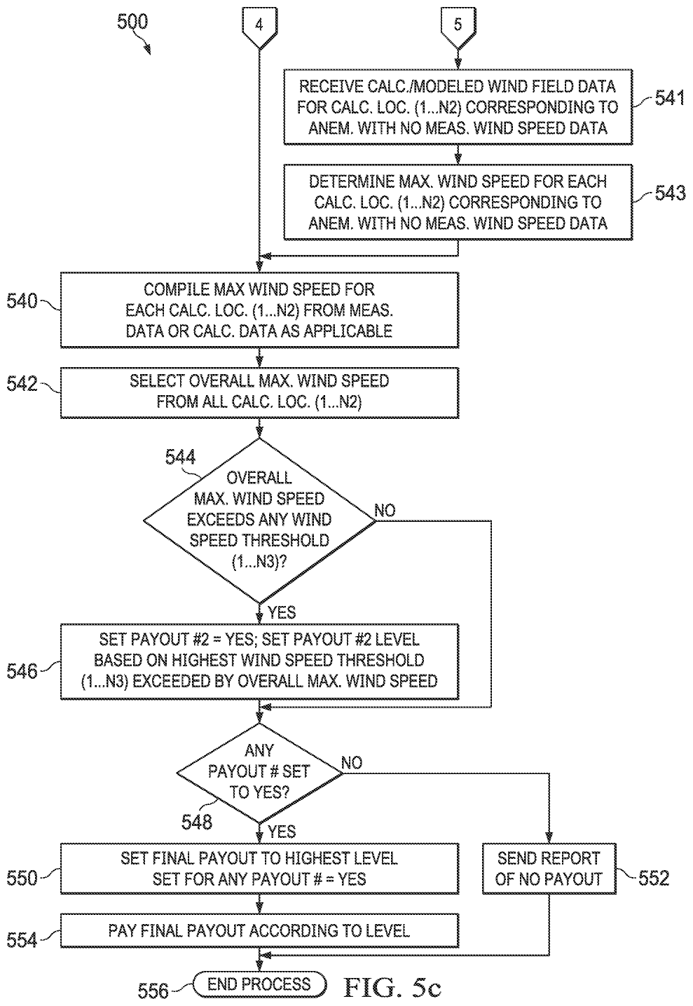

Referring now to FIGS. 5a, 5b and 5c, there is illustrated an example of a process for managing multi-trigger parametric data 500 in accordance with some embodiments of the disclosed subject matter. In FIGS. 5a-5c, the example process 500 is illustrated by means of a block diagram wherein each block represents a step or steps of the process. In some embodiments, additional blocks can be present in between and/or in series with and/or in parallel with the blocks illustrated and/or additional steps can be present between and/or in series with and/or in parallel with the steps described.

In some embodiments, the multi-trigger parametric data process 500 can be executed by any device or combination of devices. For example, the multi-trigger parametric data process 500 can be executed at least in part by one or more data servers (e.g. the data server 302 of FIG. 3), one or more user devices (e.g., the user device 304 of FIG. 3), one or more wind stations (e.g., the wind stations 310 of FIG. 3 and/or wind station system 100 of FIG. 1), one or more tide stations (e.g., the tide station 312 of FIG. 3 and/or tide station system 200 of FIG. 2a), one or more certification servers (e.g., the certification server 306 of FIG. 3), one or more third-party servers (e.g., third party payout service 318′, the National Hurricane Center server 318″ or the calculated wind model server 318′″ of FIG. 3), one or more contract payout servers 308 and/or any other suitable device.

The multi-trigger parametric data process 500 can define a plurality of trigger events, wherein each of the plurality of trigger events includes one or more predetermined trigger event data types and values. Two examples of trigger events are a Parametric Storm Category Proximity event (also known as “Cat-In-A-Circle” event or “C-I-C” event) and a Parametric Wind Speed event (“PWS” event). A C-I-C trigger event can be defined by parameter data types including, but not limited to, a C-I-C calculation location, a C-I-C covered radius, one or more C-I-C storm magnitude thresholds (1 . . . N₁), and/or one or more C-I-C payout fractions corresponding to each of the C-I-C storm magnitude thresholds. Values for each of these parameters can be provided to initialize the process. A PWS trigger event can be defined by parameters data types including, but not limited to, a PWS sustained wind speed duration, one or more PWS wind speed calculation locations (1 . . . N₂), one or more PWS wind speed thresholds (1 . . . N₃), and/or one or more PWS payout fractions corresponding to each of the PWS wind speed thresholds. Values for each of these parameters can be provided to initialize the process.

Referring now first to FIG. 5a, in some embodiments, the multi-trigger parametric data process 500 can begin at block 502 having steps of initiating the definition of one or more trigger events. In the illustrated embodiment, the process 500 can include blocks 504, 506 and 508 relating to defining a C-I-C event as one trigger event. In some embodiments, the process 500 can include block 504 having steps wherein the C-I-C event can be defined by a parameter data type including a C-I-C calculation location and one or more calculation location values is entered. The steps of blocks 504, 506 and 508 can follow the steps of block 502, and the steps of each block 504, 506 and 508 can be performed in any order (i.e., before, after or concurrently) relative to the remaining of these blocks. In some embodiments, the process 500 can include block 506 having steps wherein the C-I-C event can be defined by a parameter data type including a C-I-C covered radius and one or more covered radius values is entered. In some embodiments, the process 500 can include block 508 having steps wherein the C-I-C event can be defined by a parameter data type including one or more C-I-C storm magnitude thresholds (1 . . . N₁) and one or more storm magnitude threshold values are entered. In some embodiments, the block 508 can further include steps wherein one or more C-I-C payout fractions (i.e., values) can be entered corresponding to each of the C-I-C storm magnitude thresholds. As examples: in some embodiment, the C-I-C calculation location of block 504 can be a specified geographic latitude/longitude combination; in some embodiments the C-I-C covered radius can be a distance in miles or kilometers; in some embodiments the one or more C-I-C storm magnitude thresholds (1 . . . N₁) can be tropical storm magnitudes (“categories” or “Cats”) according to the National Hurricane Center (“NHC”) or other selected agency; and in some embodiments the corresponding one or more C-I-C payout fractions can be percentages of a predetermined maximum amount (“MaxPayout”). The steps of each block 504, 506 and 508 can be performed in any order (i.e., before, after or concurrently) relative to the remaining blocks. As further examples, if C-I-C storm magnitude thresholds is selected as the parameter data type in block 508 and if NHC Cat 4 and Cat 5 are selected as C-I-C storm magnitude threshold values, then N₁=2 and the set of N₁ C-I-C storm magnitude thresholds would be (CAT4, CAT5). Continuing with a further example, the C-I-C payout fractions corresponding to each Cat (1 . . . N₁) can be set as desired, e.g., for CAT4, the payout fraction=50% of MaxPayout and for CAT5, the payout fraction=100% of MaxPayout; thus in this example the set of N₁ C-I-C payout fractions would be (50%, 100%). The exemplary C-I-C parametric event can be satisfied (i.e., set to “YES”) if a storm track passes within the C-I-C covered radius (e.g., 20 miles) from the C-I-C calculation location (e.g., lat=X, lon=Y) with a reported magnitude (e.g., NHC-reported CAT) equal to one of the C-I-C storm magnitude thresholds, and once the C-I-C parametric event is satisfied, then the C-I-C payout fraction corresponding to the maximum exceeded storm magnitude threshold would be triggered.

In the illustrated embodiment, the process 500 can include blocks 509, 510 and 512 relating to defining a PWS event as another trigger event. In some embodiments, the process 500 can include block 509 having steps wherein the PWS event can be defined by a parameter data type including a PWS sustained wind speed duration and a sustained wind speed duration value is entered. In some embodiments, the process 500 can include block 510 having steps wherein the PWS event can be defined by a parameter data type including one or more PWS wind speed calculation locations (1 . . . N₂) and one or more wind speed calculation location values are entered. The steps of blocks 509, 510 and 512 can follow the steps of block 502, and the steps of each block 509, 510 and 512 can be performed in any order (i.e., before, after or concurrently) relative to the remaining of these blocks. In some embodiments, the process 500 can include block 512 having steps wherein the PWS event can be defined by a parameter data type including one or more PWS wind speed thresholds (1 . . . N₃) and one or more wind speed thresholds values are entered. In some embodiments, the block 512 can further include steps wherein one or more PWS payout fractions (i.e., values) can be entered corresponding to each of the PWS wind speed thresholds. As examples: in some embodiments, the PWS sustained wind speed duration of block 509 can be a specified time period (e.g., 60-seconds); in some embodiments, each PWS wind speed calculation location (1 . . . N₂) of block 510 can be the specified geographic latitude/longitude combination of a wind station 310 (e.g., with anemometer 104); in some embodiments, each PWS wind speed threshold (1 . . . N₃) of block 512 can be a range of wind speeds (e.g., in miles per hour); and in some embodiments, the corresponding PWS payout fractions can be percentages of a predetermined maximum amount (“MaxPayout”). As further examples, if PWS wind speed duration is selected as the parameter type in block 509 and if three wind calculation locations can be specified (N₂=3) with PWS calculation location set (lat₁/lon₁, lat₂/lon₂, lat₃/lon₃) and two PWS wind speed thresholds can be specified (N₃=2) with PWS wind speed threshold(1) being (130 mph<=wind speed<157 mph) and PWS wind speed threshold(2) being (157 mph<=wind speed). Continuing with a further example, the PWS payout fractions corresponding to the PWS wind thresholds can be PWS payout fraction(1)=50% of MaxPayout and PWS threshold(2)=100% of MaxPayout. The exemplary PWS parametric event can be satisfied (i.e., set to “YES”) if, at any of the PWS calculation locations (1 . . . N₂), the storm wind speed data exceeds one of the PWS wind speed thresholds (1 . . . N₃) for the specified time duration (or longer), and once the PWS parameter event is satisfied, the triggered PWS payout fraction is the fraction corresponding to the highest PWS wind speed threshold exceeded. In some embodiments, the maximum sustained PWS wind speed at any of the PWS calculation locations can first be determined, and then only the value of the maximum PWS wind speed can be compared against the PWS wind speed thresholds to determine if a trigger condition is satisfied. In other embodiments, the highest sustained PWS wind speed at each PWS calculation location can first be determined and compared to the PWS wind speed thresholds to determine if a trigger condition is satisfied for that location, and then all of the satisfied trigger conditions (if any) can compared to determine the highest trigger condition satisfied.

Referring still to FIG. 5a, the process 500 can include block 514 that includes steps of ending the initialization procedure and beginning the event monitoring procedure. In some embodiments, the steps of block 514 can follow blocks 504, 506, 508, 509, 510 and 512. In some embodiments, the process 500 can include block 516 having steps wherein the storm track data is received comprising time and location values for the storm. In some embodiments, the steps of block 516 can follow the steps of block 514. In some embodiments, the storm location values may be a set of latitude/longitude coordinate pairs defining the path of the center of the hurricane's eye as periodically determined by the relevant authorities. In some embodiments, the process 500 can include block 518 having steps wherein the storm magnitude data is received comprising times and magnitude (or category) locations for the storm. In some embodiments, the storm magnitude values may be a set of magnitude/category values for the storm as periodically determined by the relevant authorities. The steps of each block 516 and 518 can be performed in any order (i.e., before, after or concurrently) relative to the remaining of these blocks.

In some embodiments, the process 500 can include block 520 having steps of evaluating the storm track data (e.g., from block 516) and determining, for a given time=t, if the storm track location for time=t is within the specified C-I-C covered radius (e.g., from block 506) relative to the C-I-C calculation location (e.g., from block 504). In some embodiments, the steps of block 520 can follow the steps of block 516 and 518. If the result of block 516 is “YES,” then the process 500 proceeds to block 522, whereas if the result of block 516 is “NO,” then the process 500 proceeds to the block 524.

In some embodiments, the process 500 can include block 522 having steps of evaluating the storm magnitude data (e.g., from block 518) and determining, for a given time=t, if the storm magnitude is within the specified C-I-C magnitude thresholds (e.g., from block 508), it having been also determined (in block 520) that the storm track location is within the specified C-I-C covered radius at time=t. If the result of block 522 is “YES,” (i.e., C-I-C trigger event has occurred) then the process 500 proceeds to block 526, whereas if the result of block 522 is “NO,” then the process 500 proceeds to the block 524.

In some embodiments, the process 500 can include block 526 having steps of selecting the highest CAT/magnitude threshold among the thresholds (1 . . . N1) (block 508) that is satisfied by the received CAT/magnitude data (block 518) for time=t.

In some embodiments, the process 500 can include block 528 having steps of setting a trigger status of Payout #1 to “YES” (the default trigger status is “NO”) and determining a level (i.e., value) of Payout #1 according to a correspondence between the maximum CAT/magnitude threshold satisfied according to the steps of block 526 and the C-I-C payout fraction corresponding to the selected maximum CAT/magnitude. In some embodiments, the steps of block 528 can follow block 526. Following the steps of block 528, the process 500 continues to block 530 (FIG. 5b) via diagram connector 1.

In some embodiments, the process 500 can include block 524 having steps of determining whether measured wind speed data was received from anemometers at anemometer calculation locations (1 . . . N2). If the result of block 524 is “YES,” then the process 500 proceeds to block 532 (FIG. 5b) via diagram connector 2. If the result of block 524 is “NO,” then the process 500 loops back to block 516 to continue the event monitoring procedure.

Referring now also to FIG. 5b, in some embodiments, the process 500 can include block 532 having steps of evaluating the measured wind speed data from the anemometers at anemometer calculation locations (1 . . . N2) and determining whether the measured wind speed value at time=t exceeds the previous maximum wind speed value. If the result of block 532 is “YES,” then the process 500 proceeds to block 534. If the result of block 532 is “NO,” then the process 500 proceeds to block 530.

In some embodiments, the process 500 can include block 534 having steps of saving (i.e., storing) the measured wind speed value received from block 532 for anemometer calculation location (n) as a new maximum wind speed for that anemometer calculation location. In some embodiments, the process 500 then proceeds to block 530.

In some embodiments, the process 500 can include block 530 having steps of determining whether additional event data is available. If the result of block 530 is “YES” (i.e., more data to process), then the process 500 loops back to block 516 (FIG. 5a) via diagram connector 3 to continue the event monitoring procedure. If the result of block 530 is “NO” (i.e., no more data to process), then the process 500 proceeds to block 536. By the action of block 530, the process 500 can iterate through all event data including, but not limited to, the data for each C-I-C calculation location, for each anemometer calculation location and for all times t between t=0 and t=Event End.

In some embodiments, the process 500 can include block 536 having steps of determining whether no measured wind speed data was received from the anemometers at any anemometer calculation location (1 . . . N2). For example, this step can check for data interruptions due to damage to the wind speed station and/or communication links throughout the system hardware 100, 200, 300 and 400. If the result of block 536 is “YES” (i.e., no data received from anemometers at one or more particular calculation locations), then the process 500 proceeds to block 538. If the result of block 532 is “NO” (i.e., data received from all anemometer locations), then the process 500 proceeds to block 540 (FIG. 5c) via diagram connector 4.

In some embodiments, the process 500 can include block 538 having steps of using an alternative wind trigger parameter for anemometer calculation locations (1 . . . N2) where no measured wind speed data was received. The process 500 then proceeds to block 541 (FIG. 5c) via diagram connector 5.

Referring now also to FIG. 5c, in some embodiments, the process 500 can include block 541 having steps of receiving calculated or modeled wind field data for anemometer calculation locations (1 . . . N2) where no measured wind speed data was received. The process 500 then proceeds to block 543.

Referring now also to FIG. 5c, in some embodiments, the process 500 can include block 541 having steps of receiving calculated or modeled wind field data for anemometer calculation locations (1 . . . N2) where no measured wind speed data was received. The process 500 then proceeds to block 543.

In some embodiments, the process 500 can include block 543 having steps of determining, for each anemometer calculation locations (1 . . . N2) where no measured wind speed data was received, a calculated maximum wind speed. This calculated maximum wind speed can be used in the same manner as the measured wind speeds in subsequent processes. The process 500 then proceeds to block 540.

In some embodiments, the process 500 can include block 540 having steps of compiling, for all anemometer calculation locations (1 . . . N2) maximum wind speed data comprising measured wind speed data or calculated wind speed data. The process 500 then proceeds to block 542.

In some embodiments, the process 500 can include block 542 having steps of selecting an overall maximum wind speed for all anemometer calculation locations (1 . . . N2). The process 500 then proceeds to block 544.

In some embodiments, the process 500 can include block 544 having steps of determining whether the overall maximum wind speed (for all anemometer calculation locations (1 . . . N2)) exceeds any of the wind speed thresholds (1 . . . N3). If the result of block 544 is “YES,” then the process 500 proceeds to block 546. If the result of block 544 is “NO,” then the process 500 proceeds to block 548.

In some embodiments, the process 500 can include block 546 having steps of setting a trigger status of Payout #2 to “YES” (the default trigger status is “NO”) and determining a level (i.e., value) of Payout #2 according to a correspondence between the maximum wind speed threshold (1 . . . N3) satisfied according to the steps of block 544 and the PWS payout fraction corresponding to the selected maximum wind speed threshold. The process 500 then proceeds to block 548.

In some embodiments, the process 500 can include block 548 having steps of determining whether any Payout #N has the trigger status=“YES”. If the result of block 548 is “YES,” then the process 500 proceeds to block 550. If the result of block 548 is “NO,” then the process 500 proceeds to block 552.

In some embodiments, the process 500 can include block 550 having steps of setting the Final Payout to the highest level/value set for any Payout #N having a trigger status=“YES.” The process 500 then proceeds to block 554.

In some embodiments, the process 500 can include block 552 having steps of sending a report of “No Payout” for the subject event when the process determines that no payout is indicated by the relevant parameters and measured values. The process 500 then proceeds to block 556.

In some embodiments, the process 500 can include block 554 having steps of paying a Final Payout according to the payout level/value set in block 550. In some embodiments, the process can also include steps of sending a report of “Payout for Event” for the subject event when the process determines that a payout is indicated by the relevant parameters and measured values. The process 500 then proceeds to block 556.

In some embodiments, the process 500 can include block 556 having steps of ending the multi-trigger parametric data management process.

In some embodiments of the multi-trigger parametric data process 500, the storm wind speed data used for the PWS wind speed thresholds (block 512) is measured wind speed data obtained from the one or more wind stations 310 (e.g., anemometers) at the specified PWS calculation locations. In other embodiments, the storm wind speed data is obtained from a calculated (i.e., modeled) wind field data set. The calculated wind field data set can be a data set provided by the operator of the process or obtained by the operator of the process from a third-party provider such as a RMS® North Atlantic Hurricane Models from Risk Management Solutions, Inc. In still other embodiments, storm wind speed data used for the PWS wind speed thresholds can be obtained from both measured wind speed data and from calculated wind field data.

In the process 500 illustrated in FIGS. 5a-5c, the primary source of storm wind speed data used for the PWS wind speed threshold comparison is measured wind speed data from wind stations 310. However, in circumstances wherein measured wind speed data is not available from one or more of the PWS calculation locations, then a secondary (i.e., “backup”) source of storm wind speed data is used for the PWS wind speed threshold comparison at those PWS calculation locations. For example, at PWS calculation locations where no measured wind speed data is obtained (block 536), e.g., due to equipment failure, data loss or other unexpected circumstance, then a calculated wind field data set is obtained (blocks 538 and 542) covering the relevant PWS calculation locations, and the maximum (calculated) sustained wind at the relevant PWS calculation location is extracted (block 544) from the wind field data set for use as the PWS wind speed data (block 540). The maximum PWS wind speed is then selected (block 540) from all of the PWS wind speeds at all of the PWS calculation locations using the primary (e.g., measured) wind speed data if available and using the secondary (e.g., calculated) wind speed data if the primary data is not available. The maximum PWS wind speed from all the PWS calculation locations is then compared (block 544) to the PWS wind speed thresholds to determine the maximum PWS wind speed threshold exceeded. If so, the PWS payout fraction associated with the highest PWS wind speed threshold exceeded is triggered (block 546).

In some embodiments of the multi-trigger parametric data process 500, other parametric trigger events can be used in a multi-trigger parametric data process. For example, a Parametric Tide Event (“PTE”) can be defined by parameter data types including, but not limited to, one or more PTE tide calculation locations (1 . . . N₄), one or more PTE tide level thresholds (1 . . . N₅), and one or more PTE payout fractions corresponding to each of the PTE tide level thresholds. Values for each of these parameters are provided to initialize the process. As examples: In some embodiments, the PTE tide level calculation location (1 . . . N₄) can be the specified geographic latitude/longitude combination of a tide station 312 (e.g., with tide gauge/water level gauge 202); in some embodiments, each PTE tide level threshold (1 . . . N₅) can be a range of tide levels (e.g., in feet or inches) provided either in terms of absolute measurement (i.e., above MLLW) or in terms of storm surge variance from predicted (i.e., astronomical) tide levels (e.g., variance=measured water level−predicted water level) for the calculation location; and in some embodiments, the corresponding PTE payout fractions can be percentages of a predetermined maximum amount (“MaxPayout”). The PTE parametric event can be satisfied (i.e., set to “YES”) if, at any of the PTE calculation locations (1 . . . N₄), the tide level data exceeds one of the PTE tide level thresholds (1 . . . N₅). If so, the triggered PTE payout fraction is the fraction corresponding to the highest PTE tide level threshold exceeded. In a similar fashion, an additional parametric trigger event can be a Parametric Flooding Event (“PFE”), which is substantially similar to the PTE, except the water levels of interest are water levels at PFE calculation locations in potential flood areas rather than on tidal coastlines.

In some embodiments, at least some of the above-described blocks and/or steps of the multi-trigger parametric data processes can be executed or performed in any order or sequence not limited to the order and sequence shown in and described in connection with the figures. Also, some of the above blocks and/or steps of FIGS. 5a-5c can be executed or performed substantially simultaneously where appropriate or in parallel to reduce latency and processing times. Additionally or alternatively, some of the above described blocks and/or steps of the processes of FIGS. 5a-5c can be omitted.

In some embodiments, any suitable computer readable media can be used for storing instructions for performing the functions and/or processes herein. For example, in some embodiments, computer readable media can be transitory or non-transitory. For example, nontransitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

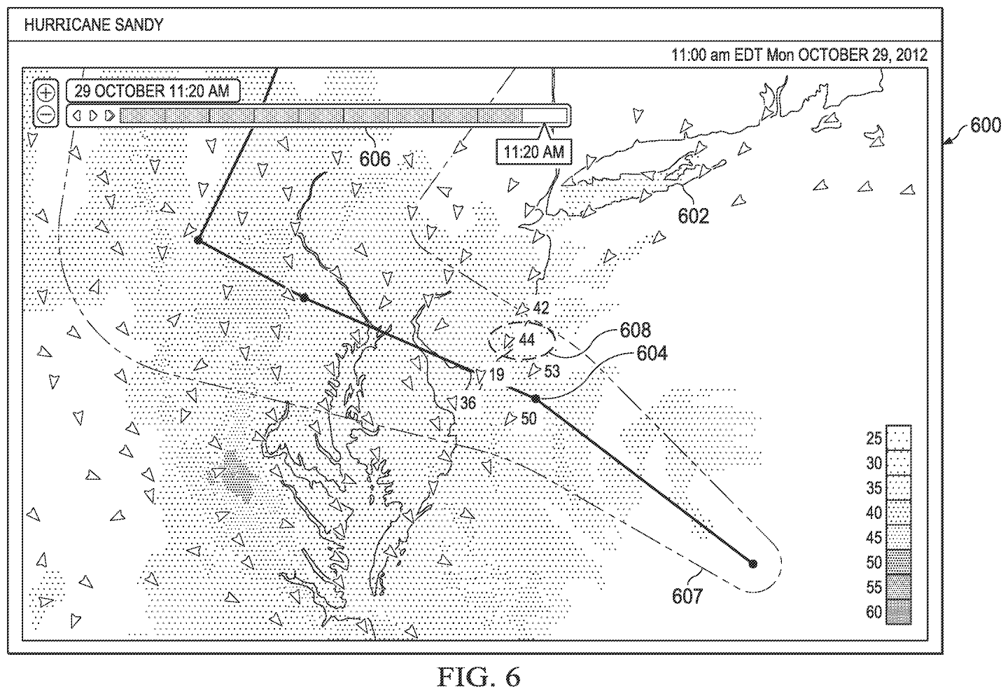

Referring now to FIG. 6, there is illustrated an exemplary storm track map 600 for a tropical storm including underlying geographic features 602, storm path location data 604 and time data 606, hurricane speed wind boundary/envelope 607 and wind speed and direction data 608. For purposes of illustration, wind speed data is shown for only some of the exemplary wind speed and direction data 608 in the FIG. 6. This storm track map is exemplary of a data set that can be obtained from third party servers such as servers at the National Hurricane Center to provide input data, measured data and/or calculated data for use in the processes disclosed herein.

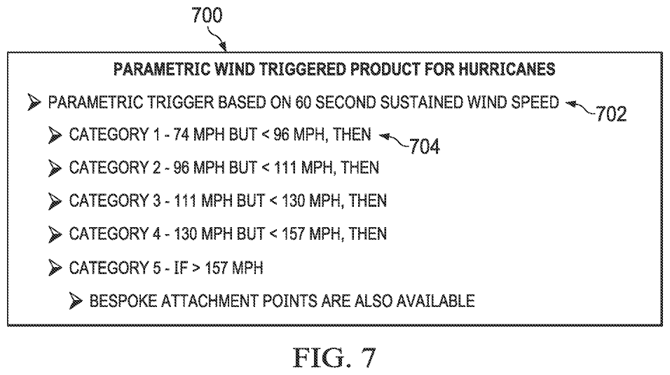

Referring now to FIG. 7, there is illustrated an exemplary set 700 of parametric wind triggers for a hurricane that can used to provide input data (e.g., PWS wind speed thresholds) for evaluating a Parametric Wind Speed portion of a multi-trigger parametric data process in accordance with the embodiments disclosed herein. In the illustrated embodiment, one parametric trigger data type 702 is a sustained wind speed and the trigger value is set for a time=60 seconds. In the illustrated embodiment, five wind speed thresholds 704 are specified, each wind speed threshold corresponding to a respective value on the CAT scale of wind speed.

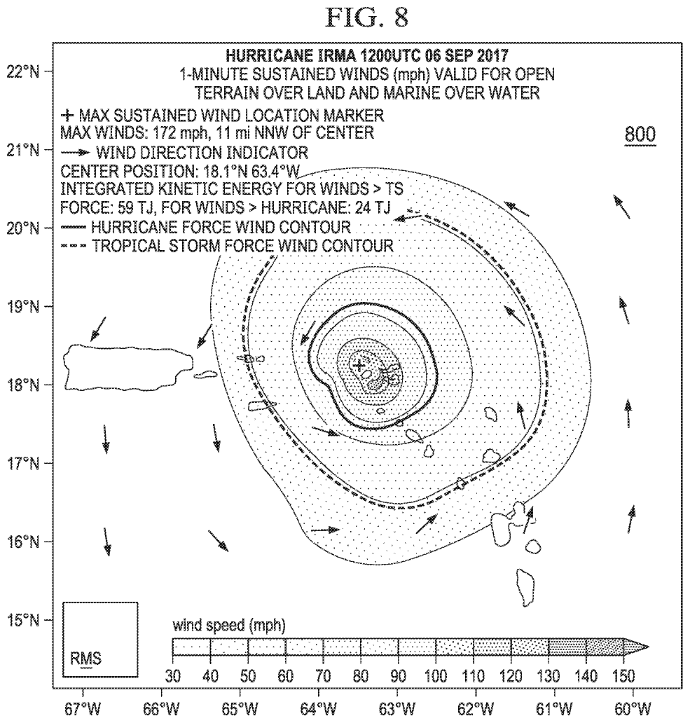

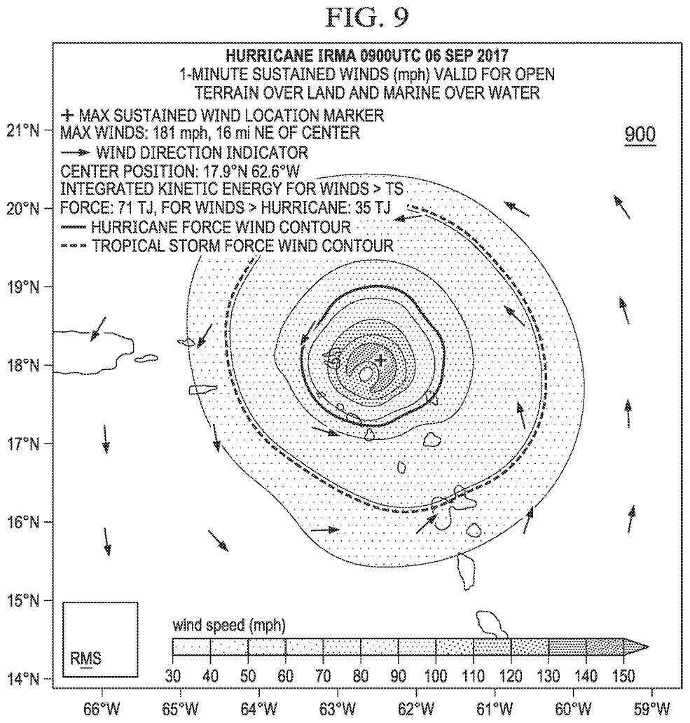

Referring now to FIGS. 8 and 9, there are illustrated two different calculated (i.e., modeled) wind field footprint charts 800 and 900 for an exemplary tropical storm (i.e., Hurricane Irma, 2017) at two different specified times in accordance with another type of parametric data used in embodiments disclosed herein. These wind field charts are exemplary of RMS® data sets that can be obtained from third party servers such as servers at the Risk Management Solutions, Inc. to provide input data, measured data and/or calculated data for use in the processes disclosed herein. In the process illustrated in FIGS. 5a-5c, calculated wind field charts or similar calculated (i.e., modeled) data sets can be used as a source of secondary (“backup”) wind speed data in cases (e.g., blocks 538, 542 and 544 of FIG. 5b) where measured wind speed data (i.e., from specific anemometers) is not available. In other embodiments, calculated/modeled wind field charts or similar data sets can be used a primary wind speed data for some or all of the calculation locations.

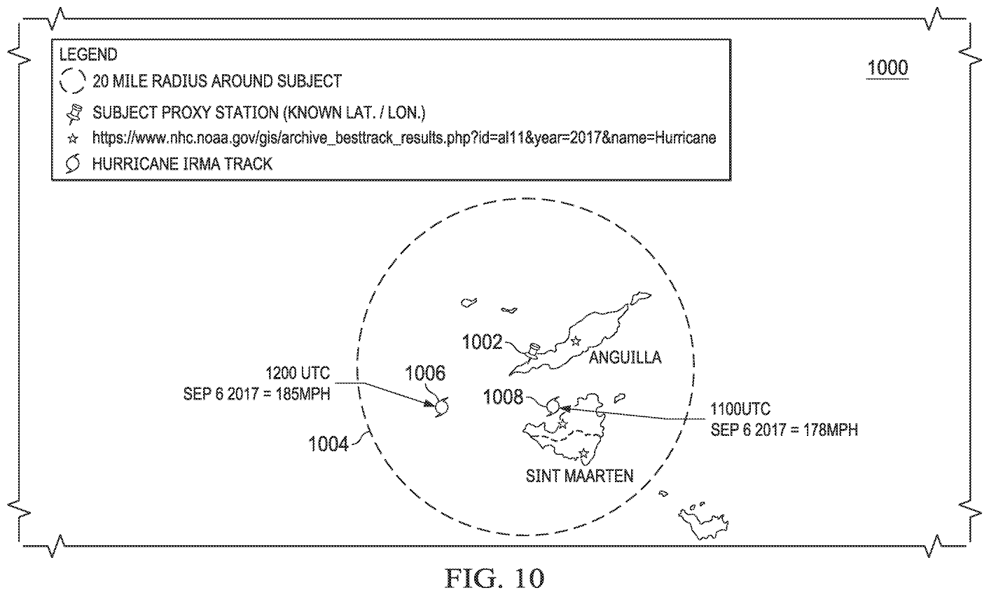

Referring now to FIG. 10, there is illustrated an exemplary coverage territory map 1000 for a Cat-In-A-Circle (“C-I-C”) type parametric process for a hurricane. In the example map, the C-I-C calculation location 1002 has input data of lat 18.177581/lon −63.144625 and the C-I-C covered radius 1004 has input data of 20 miles. Two storm track data points 1006 and 1008 are provided representing the location and wind speed of Hurricane Irma 2017 at 1100 UTC and 1200 UTC, respectively. Both of the illustrated storm track data points 1006 and 1008 lie within the 20-mile CIC covered radius 1004 from the calculation location 1002, and thus can potentially trigger a C-I-C depending upon a comparison of the reported wind speed data and the previously designated C-I-C storm magnitude thresholds.

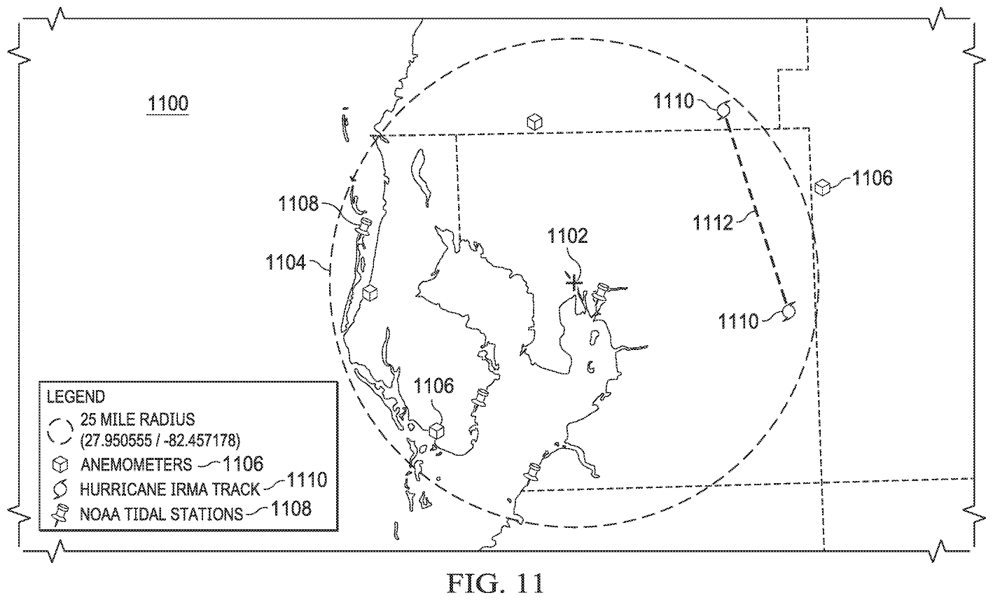

Referring now to FIG. 11, there is illustrated an exemplary triggering mechanisms map 1100 for a multi-trigger parametric data process including Cat-In-A-Circle (C-I-C) Parametric event, Parametric Wind Speed (PWS) event and Parametric Tide (PTE) event. Illustrated are input data for these processes including the C-I-C calculation location 1102 and C-I-C covered radius 1104, PWS calculation locations 1106 (i.e., anemometer locations) and PTE locations 1108 (i.e., NOAA tidal stations). Also illustrated are two storm track data points 1110 and an approximate path line 1112 (shown in dashed lines) for Hurricane Irma 2017 that can be used for evaluating the various trigger events. Each respective triggering condition can define a plurality of respective levels to be met and payout fractions corresponding thereto. The payout for the event can be the maximum amount multiplied by the maximum met payout fraction for all of the triggering conditions.

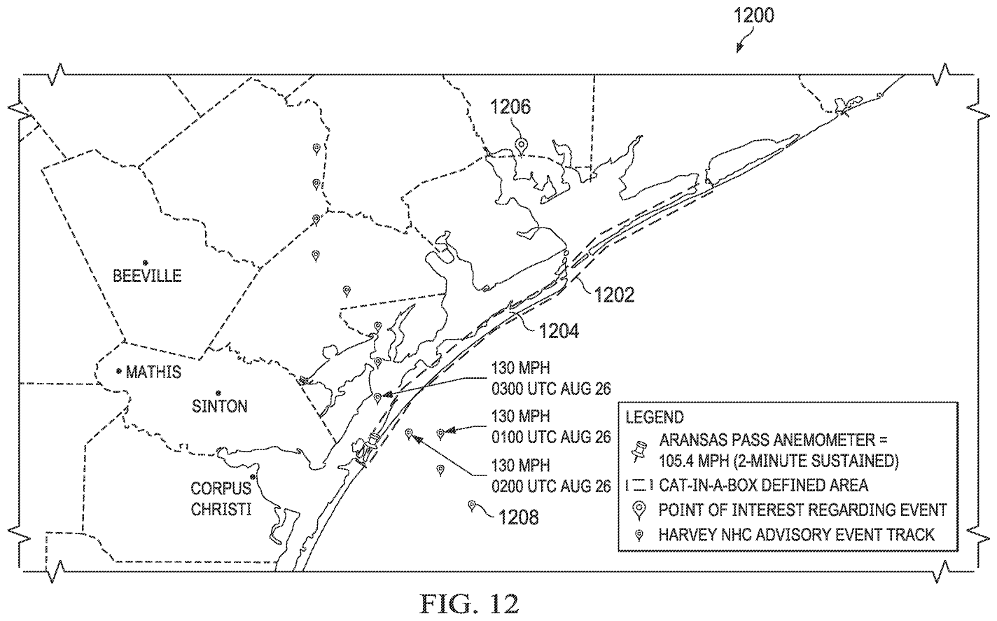

Referring now to FIG. 12, there is illustrated another exemplary triggering mechanisms/exposure map 1200 showing multiple-trigger input data and parametric data values. The first triggering condition is a Cat-in-a-Box, i.e., storm track of predefined magnitude (i.e., CAT) crossing a first predefined geographic location, wherein the first predefined geographical location is an elongated polygon 1202 defined by a plurality of latitude/longitude points to roughly correlate with certain geographic features of interest 1204, e.g., barrier islands. The second triggering condition is a measured wind speed at a second predefined geographic location, namely, an actual anemometer location 1206. Storm track parametric data from event Hurricane Harvey include announced storm track data points 1208 released by the NHC, with each storm track data point including respective time, position and wind speed data. Each respective triggering condition can define a plurality of respective levels to be met and payout fractions corresponding thereto. The payout for the event can be the maximum amount multiplied by the maximum met payout fraction for all of the triggering conditions.

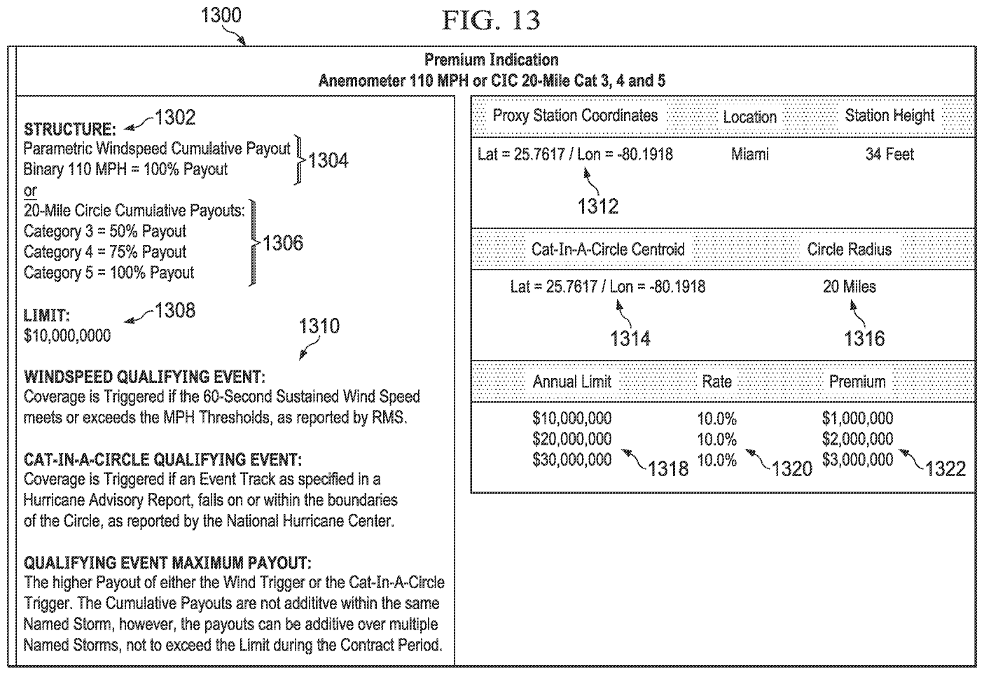

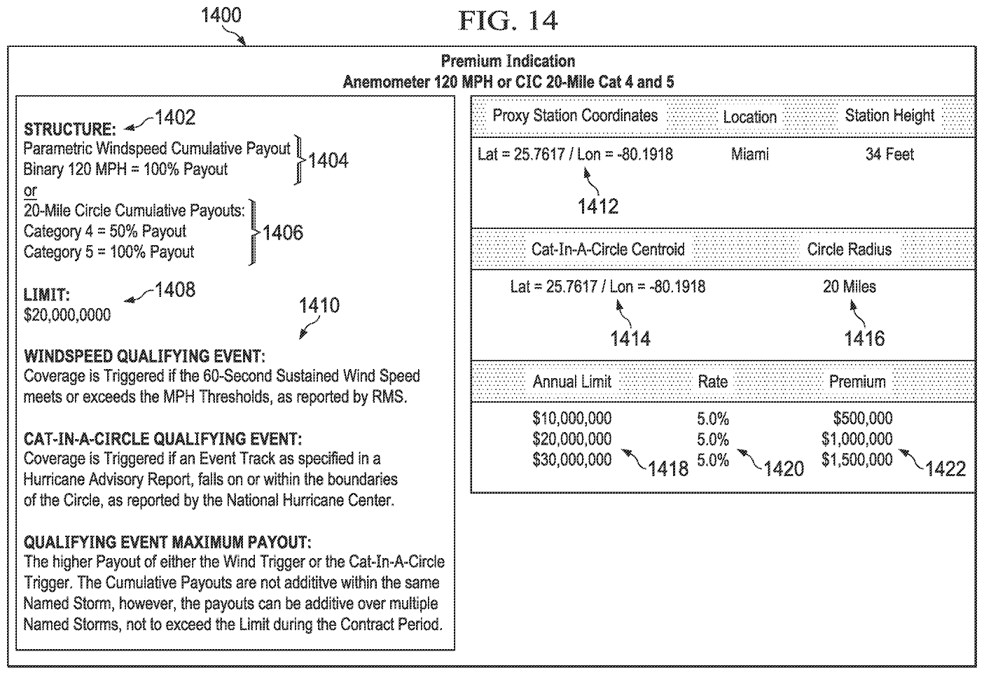

Referring now to FIGS. 13 and 14, there are illustrated two exemplary premium indications 1300 and 1400 based on multi-trigger (e.g., binary) parametric data management and transactions in accordance with embodiments of the disclosed subject matter. The parameter values provided on the premium indications 1300, 1400 represent input data for a multi-trigger parametric process including, but not limited to, the process 500 shown in FIGS. 5a-5c that can be used to determine whether a multi-trigger parametric event has been triggered. If so, the process can determine which threshold level of the parameters are triggered by the event and the associated level of payout specified by the input values.

Referring first to FIG. 13, in the illustrated embodiment, the premium indication 1300 can include a multi-trigger structure portion 1302 specifying a first parametric trigger event 1304 and a second parametric trigger event 1306. In the illustrated embodiment, the first parametric trigger event 1304 can be a wind speed event data type having a parametric trigger value=110 MPH. Triggering the first parametric trigger event 1304 results in a Payout #1 with payout fraction set at 100% of MaxPayout. In the illustrated embodiment, the second parametric trigger event 1306 can be a Cat-In-A-Circle event data type having a parametric trigger value=20 Mile Circle. Triggering the second parametric trigger event 1306 results in a Payout #2 with payout fraction set to 50%, 75% or 100% of MaxPayout according to correspondence between the Category (“Cat” or “CAT”) level 3, 4, or 5 (respectively) of the storm when it is within the parametric circle. In the illustrated embodiment, the premium indication 1300 can include a Limit portion 1308 specifying the value for MaxPayout, in this example, MaxPayout=$10,000,000. In the illustrated embodiment, the premium indication 1300 can include an Information portion 1310 providing further details of the parametric trigger events 1304 and 1306 and of the maximum payout conditions (e.g., for blocks 550 and 554 of FIG. 5c). In the illustrated embodiment, the premium indication 1300 can include an input section including location coordinates 1312 for the C-I-C wind speed calculation location (e.g., for block 504 of FIG. 5a), Cat-In-A-Circle center location coordinates 1314 and radius 1316 (e.g., for block 506 of FIG. 5a). In the illustrated embodiment, the premium indication 1300 can include respective annual limit values 1318, coverage rate values 1320 and premium amount values 1322 corresponding to the desired MaxPayout requested by a purchaser. In other embodiments, any of the parametric data types and values in the premium indication 1300 can be changed, modified, or substituted in accordance with the purchaser's requirements and/or type of risk to be insured against.

Referring now to FIG. 14, in the illustrated embodiment, the premium indication 1400 can include a multi-trigger structure portion 1402 specifying a first parametric trigger event 1404 and a second parametric trigger event 1406. In the illustrated embodiment, the first parametric trigger event 1404 can be a wind speed event data type having a parametric trigger value=120 MPH. Triggering the first parametric trigger event 1404 results in a Payout #1 with payout fraction set at 100% of MaxPayout. In the illustrated embodiment, the second parametric trigger event 1406 can be a Cat-In-A-Circle event data type having a parametric trigger value=20 Mile Circle. Triggering the second parametric trigger event 1406 results in a Payout #2 with payout fraction set to 50% or 100% of MaxPayout according to correspondence between the Category (Cat) level 4 or 5 (respectively) of the storm when it is within the parametric circle. In the illustrated embodiment, the premium indication 1400 can include a Limit portion 1408 specifying the value for MaxPayout, in this example, MaxPayout=$20,000,000. In the illustrated embodiment, the premium indication 1400 can include an Information portion 1410 providing further details of the parametric trigger events 1404 and 1406 and of the maximum payout conditions (e.g., for blocks 550 and 554 of FIG. 5c). In the illustrated embodiment, the premium indication 1400 can include an input section including location coordinates 1412 for the C-I-C wind speed calculation location (e.g., for block 504 of FIG. 5a), Cat-In-A-Circle center location coordinates 1414 and radius 1416 (e.g., for block 506 of FIG. 5a). In the illustrated embodiment, the premium indication 1400 can include respective annual limit values 1418, coverage rate values 1420 and premium amount values 1422 corresponding to the desired MaxPayout requested by a purchaser. In other embodiments, any of the parametric data types and values in the premium indication 1300 can be changed, modified, or substituted in accordance with the purchaser's requirements and/or type of risk to be insured against.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

1. A distributed system for assessing natural disaster events, the system comprising:
a remote station configured to measure first parametric data;
a certification station configured to certify the first parametric data and second parametric data; and
a parametric station communicatively coupled to the remote station and the certification station, the parametric station configured to:
establish, prior to a natural disaster event, a first trigger condition based on comparing the first parametric data to a first set of input values and a second trigger condition based on comparing the second parametric data to a second set of input values, wherein the second parametric data is a different parametric data type than the first parametric data;
receive first values for the first parametric data from the remote station and second values for the second parametric data from an external source resulting from the event;
receive, from the certification station, a certification report for the first parametric data and the second parametric data corresponding to the remote station;
determine that the first values and the second values are accurate based on the certification report;
compare the first values to the first set of input values to determine the first trigger conditions are met,
compare the second values to the second set of input values to determine the second trigger conditions are met;
determine a more accurate condition between the first values and the second values;
determine a payout amount based on the more accurate condition; and
in response to determining the payout amount, transmit a signal to an external server that causes payout of a contract at the payout amount.

2. The system in accordance with claim 1, wherein:
the remote station is located at a predefined geographical location, the remote station configured to measure seismic magnitude values of a seismic magnitude as the first values of the first parametric data,
the first set of input values includes a predefined input seismic magnitude value and the predefined geographical location, and
the first trigger condition is a seismic magnitude value at the remote station that is greater or equal to the predefined input seismic magnitude value.

3. The system in accordance with claim 1, wherein:
the remote station includes an anemometer at a predefined geographical location, the anemometer configured to measure storm wind speed values of a storm wind speed as the first values of the first parametric data,
the first set of input values includes a predefined input wind speed value and the predefined geographical location, and
the first trigger condition is a storm wind speed value at the remote station that is greater or equal to the predefined input wind speed value.

4. The system in accordance with claim 3, wherein the storm wind speed value is a measured wind speed determined by the anemometer located at the predefined geographical location.

5. The system in accordance with claim 3, wherein the storm wind speed value is a calculated wind speed determined by a wind field calculation for the predefined geographical location.

6. The system in accordance with claim 3, wherein:
when the anemometer at the predefined geographical location provides usable data, the storm wind speed value is a measured wind speed determined by the anemometer located at the predefined geographical location, and
when the anemometer does not provide usable data, the storm wind speed value is a calculated wind speed determined by a wind field calculation for the predefined geographical location.

7. The system in accordance with claim 1, wherein:
the second values for the second parametric data are determined wind speed values for a storm track associated with the natural disaster event,
the second set of input values includes one or more categories of wind speed values and a predefined closed geographical area, and
the second trigger condition is the storm track crosses the predefined closed geographical area and a storm wind speed of the storm track in the predefined closed geographical area is within the one or more categories.

8. The system in accordance with claim 7, wherein the predefined closed geographical area is a circle of a predetermined radius drawn around a predetermined latitude/longitude point.

9. The system in accordance with claim 7, wherein the predefined closed geographical area is a square of a predetermined side length centered on a predetermined latitude/longitude point.

10. The system in accordance with claim 7, wherein the predefined closed geographical area is a rectangle defined by four predetermined latitude/longitude points.

11. The system in accordance with claim 7, wherein the predefined closed geographical area is a polygon defined by a plurality of predetermined latitude/longitude points.

12. The system in accordance with claim 7, wherein the parametric station is further configured to, in response to the storm track crosses the predefined closed geographical area and there is a single announced storm track data point within the predefined closed geographical area, determine the storm wind speed for the predefined closed geographical area is a wind speed for the single announced storm track data point.

13. The system in accordance with claim 7, wherein the parametric station is further configured to, in response to the storm track crosses the predefined closed geographical area and there is a plurality of announced storm track data points at the predefined closed geographical area, determine the storm wind speed for the predefined closed geographical area is a highest wind speed for any of the plurality of announced storm track data points within the predefined closed geographical area.

14. The system in accordance with claim 7, wherein the parametric station is further configured to, in response to the storm track crosses the predefined closed geographical area and there are no announced storm track data points within the predefined closed geographical area, determine the storm wind speed for the predefined closed geographical area is a greater value of a wind speed of an announced storm track data point immediately preceding entry into the predefined closed geographical area and a wind speed of an announced storm track data point immediately following exit from the predefined closed geographical area.

15. The system in accordance with claim 7, wherein the parametric station is further configured to, in response to the storm track crosses the predefined closed geographical area and there are no announced storm track data points within the predefined closed geographical area, determine a storm wind speed for the predefined closed geographical area as an average of a wind speed of an announced storm track data point immediately preceding entry into the predefined closed geographical area and a wind speed of an announced storm track data point immediately following exit from the predefined closed geographical area.

16. The system in accordance with claim 1, wherein the parametric station is further configured to:
establish, prior to the event, a third trigger condition based on comparing third parametric data to a third set of input values, wherein in the third parametric data is a different parametric data type than the first parametric data and the second parametric data;
receive, after the event, third values for the third parametric data resulting from the event;
receive, from the certification station, a certification report for the third parametric data;
determine that the third values are accurate based on the certification report for the third parametric data;
compare, after receiving the third values, the third values to the third set of input values to determine the third trigger conditions are met; and
determine, for each third trigger conditions that is met, a respective payout fraction of a maximum amount associated with each met condition.

17. The system in accordance with claim 16, wherein the third trigger condition is related to tide levels at a second predefined geographical location.

18. The system in accordance with claim 1, wherein the event is a wind storm and the first trigger condition and the first parametric data are related to wind speed at a first predefined geographical location and the second trigger condition and the second parametric data are related to tide levels at a second predefined geographical location.

19. A distributed system for assessing a natural disaster event, the system comprising:
a remote station configured to:
measure first parametric data, wherein the first parametric data includes respective direct wind speeds measured at at least one geographic location,
produce respective wind speed signals indicative of the respective direct wind speeds at each respective geographic location of the at least one geographic location, wherein the respective wind speed signals are one of electric signals and electronic signals;
convert the one of the electric signals and electronic signals of the respective wind speed signals into respective direct wind speed data at each respective geographic location, wherein the respective direct wind speed data is digital data;
transmit the respective direct wind speed data at each respective geographic location as digital data onto an external communications network;
one or more certification servers configured to:
receive the first parametric data including the respective direct wind speed data as digital data for each respective geographic location from the external communication network
receive second parametric data, wherein the second parametric data includes at least one of:
a storm track including position data, time data, and wind speed data;
a calculated wind field for a geographic region; and
a tide level for a geographic location; and
generate a certification report of an accuracy of the first parametric data and the second parametric data;
one or more data servers configured to:
establish a first trigger condition based on comparing first parametric data to a first set of input values;
establish a second trigger condition based on comparing the second parametric data to a second set of input values, wherein the second parametric data is a different parametric data type than the first parametric data;
receive the first parametric data including the respective direct wind speed data as digital data for each of the respective geographic locations from the external communication network;
store the second parametric data including the respective direct wind speed data for each of the respective geographic locations;
receive the second parametric data,
store the second parametric data;
determine the first parametric data meets the first trigger condition;
determine the second parametric data meets the second trigger condition;
determine a more accurate condition between the first parametric data and the second parametric data;
determine a payout amount based on the more accurate condition;
in response to determining the payout amount, transmit an indication to a payout server on the external communications network that causes payout of a contract at the payout amount; and
in response to determining that none of the first or second trigger conditions are met, transmit an indication that no payout is triggered to the payout server on the external communications network.

20. A distributed system for assessing a natural disaster event, the system comprising:
a remote station comprising:
at least one sensor configured to measure, a direct wind speed from a sensor at the remote station, wherein the direct wind speed is first parametric data; and
a remote communication interface configured to transmit the direct wind speed over an external communications network;
one or more certification servers comprising
a certification communication interface configured to:
receive the first parametric data including the direct wind speed as digital data for each respective geographic location from the external communication network; and
receive second parametric data, wherein the second parametric data includes at least one of:
a storm track including position data, time data, and wind speed data;
a calculated wind field for a geographic region; and
a tide level for a geographic location; and
a certification processor configured to generate a certification report of an accuracy of the first parametric data and the second parametric data;
a server configured to:
establishing a first trigger condition based on comparing the first parametric data to a first threshold and a second trigger condition based on comparing the second parametric data to a second threshold, wherein the second parametric data is a different parametric data type than the first parametric data;
receive the first parametric data including the direct wind speed for the remote station from the external communication network;
receive the second parametric data from an external source;
determining the first parametric data meets the first trigger condition and the second parametric data meets the second trigger condition;
determining a more accurate condition between the first trigger condition and the second trigger condition;
determining a payout amount based on the more accurate condition;
in response to determining the payout amount, transmitting an indication to a payout server on the external communications network that causes payout of a contract at the payout amount; and
in response to determining that none of the first or second trigger conditions are met, transmitting an indication that no payout is triggered to the payout server on the external communications network.
